(19) United States
(12) Patent Application Publication
(10) Pub. No.: US 2015/0233223 A1
(43) Pub. Date: Aug. 20, 2015

(54) ENHANCED OIL RECOVERY PROCESS TO INJECT SURFACTANT-AUGMENTED LOW-SALINITY WATER IN OIL-WET CARBONATE RESERVOIRS

(71) Applicants: Waleed Salem AlAmeri, Abu Dhabi (AE); Tadesse Weldu Teklu, Golden, CO (US); Ramona M. Graves, Evergreen, CO (US); Hossein Kazemi, Castle Rock, CO (US); Ali M. AlSumaiti, Abu Dhabi (AE)

(72) Inventors: Waleed Salem AlAmeri, Abu Dhabi (AE); Tadesse Weldu Teklu, Golden, CO (US); Ramona M. Graves, Evergreen, CO (US); Hossein Kazemi, Castle Rock, CO (US); Ali M. AlSumaiti, Abu Dhabi (AE)

(21) Appl. No.: 14/635,609

(22) Filed: Mar. 2, 2015

Related U.S. Application Data
(63) Continuation-in-part of application No. 14/626,362, filed on Feb. 19, 2015.
(60) Provisional application No. 61/946,062, filed on Feb. 28, 2014.
(60) Provisional application No. 61/941,869, filed on Feb. 19, 2014.

(51) Int. Cl. E21B 43/20; C09K 8/584

(52) U.S. Cl. CPC E21B 43/20; C09K 8/584

(57) ABSTRACT

The present invention relates to a method to enhance oil recovery from a hydrocarbon reservoir. One aspect of the invention includes injecting low salinity water into the reservoir followed by the injection of a surfactant diluted in low salinity water, and alternating the injections of the low salinity water and the surfactant diluted in the low salinity water. The invention improves the effectiveness of the surfactant by reducing the salinity of the reservoir by injecting low-salinity water into the reservoir.

### CROSS REFERENCE TO RELATED APPLICATIONS

This application claims priority under 35 U.S.C. §119(e) to U.S. Provisional Patent Application Ser. No. 61/946,062 filed Feb. 28, 2014, which is incorporated herein in its entirety by reference. This application is a Continuation-in-Part of U.S. patent application Ser. No. 14/626,362, filed on Feb. 19, 2015, which claims priority under 35 U.S.C. §119(e) to U.S. Provisional Patent Application Ser. No. 61/941,869 filed Feb. 19, 2014. Each of these applications is incorporated by reference in their entirety.

### FIELD OF THE INVENTION

The invention relates to a method to enhance the recovery of oil in a hydrocarbon reservoir with the injection of low salinity water and a surfactant.

### BACKGROUND

Conventional water flooding is widely used globally in carbonate oil reservoirs. The ultimate oil recovery from primary production and high salinity waterflooding is significantly less than 50%. To recover additional residual oil after a high salinity waterflood, gas flooding (such as CO₂), low-salinity water flooding, surfactant flooding, polymer flooding, steam flooding, or other enhanced oil recovery (EOR) methods can be implemented. However, low-salinity water flooding is not economical because it has to displace the already injected higher salinity water to mobilize additional residual oil.

It is believed that in carbonate formations, the carbonate rock surface attains a positive charge in presence of formation brine. The positive charge results from carbonate dissolution in brine, which also increases the solution pH. See Navratil, “An Experimental Study of Low Salinity EOR effects on a Core from the Yme Field” (Master Thesis, Petroleum Engineering Department, University of Stavanger). In presence of oil, the brine-soluble acidic components of the oil (carboxylate ions, R—COO⁻) are attracted to the positively charged carbonate rock surface. Some of these acidic oil molecules attach to the positively charged carbonate surface, which makes the surface oil-wet. This attachment is why restoring core wettability is critical factor in any improved oil recovery (IOR)/EOR experiments.

In presence of brine, the positively charged carbonate surface is amenable to anion exchange, which might be the reason for wettability alteration by the high salinity water in traditional seawater flooding. In the latter, the sulfate, calcium and magnesium ions (SO₄²⁻, Ca²⁺, Mg²⁺) compete with the carboxylate (R—COO⁻) ions to partially alter the rock wettability from oil wet to water wet. See Austad et al., “Conditions for a Low-Salinity Enhanced Oil Recovery (EOR) Effect in Carbonate Oil Reservoirs,” Energy& Fuels, 26, 569-575 (2012).

Wettability alteration is a complex issue which, in addition to the brine ionic composition, also depends on reservoir temperature. See Austad et al. “Seawater as IOR Fluid in Fractured Chalk,” SPE-93000-MS. Presented at the SPE International Symposium on Oilfield Chemistry, The Woodlands, Tex., Feb. 2-4, 2005. Previous spontaneous imbibition of water experiments were conducted using oil-saturated cores from Ekofisk, Valhall, and Yates fields. The scientists that conducted those experiments observed that the presence of SO₄²⁻ improved the spontaneous imbibition regardless of the wetting conditions. Furthermore, studies on low-salinity waterflooding in carbonate reservoirs, with reduced Na⁺, indicate that Ca²⁺, Mg²⁺, and SO₄²⁻ play a major role in the wettability alteration. See Fathi et al. “Water-Based Enhanced Oil Recovery (EOR) by “Smart Water” in Carbonate Reservoirs,” SPE 154570, presented at the SPE EOR Conference at Oil and Gas West Asia, Muscat, Oman, Apr. 16-18, 2012; Austad et al. (2012); Awolayo et al. “A Laboratory Study of Ionic Effect of Smart Water for Enhancing Oil Recovery in Carbonate Reservoirs,” SPE 169662-MS, presented at the SPE EOR Oil and Gas West Asia Conference, Muscat, Oman, Mar. 31-Apr. 2, 2012.

Some other scientists have reported an increase in oil recovery through experiments involving carbonate cores using Advanced Ion Management (AIMSM), where it adds or removes different ions from the injected water. For example, low-salinity waterflood experiments were conducted on different carbonate cores. See Gupta et al. “Enhanced Waterflood for Middle East Carbonate Cores-Impact of Injection Water Composition,” SPE 142668, presented at the SPE Middle East Oil and Gas Show and Conference, Manama, Bahrain, Sep. 25-28, 2011. In that study, carbonate cores were used for both coreflooding and spontaneous imbibition experiments at 70° C. Synthetic brine was mixed with distilled water in four ways (diluted twice, 5 times, 10 times, and 100 times). From these experiments, it was reported an increase of 16-21% in oil recovery from spontaneous imbibition experiments. Additional scientists performed several low-salinity waterflood experiments using carbonate cores. See Al-Harrasi et al. “Laboratory Investigation of Low Salinity Waterflooding for Carbonate Reservoirs,” SPE 161468, presented at the Abu Dhabi International Petroleum Exhibition & Conference, Abu Dhabi, UAE, 11-14 Nov. 11-14, 2012. Carbonates cores were used during both coreflooding and spontaneous imbibition experiments at 70° C. Synthetic brine was mixed with distilled water in four ways making varying concentrations. From these experiments, an increase of 16-21% in oil recovery with coreflooding and spontaneous imbibitions was reported. See Al-Harrasi et al. (2012).

An additional study reported contact angle change with time with low-salinity brine, both on limestone and sandstone cores from oil reservoirs in Libya. Zekri, A. Y. et al., “Effect of EOR Technology on Wettability and Oil Recovery of Carbonate and Sandstone Formation. IPTC 14131,” presented at the International Petroleum Technology Conference, Bangkok, Thailand, Feb. 7-9, 2012. Several brine injection concentrations were used in the experiment to examine the effect of salinity in oil recovery by varying sulfate concentrations. The study concluded that wettability alteration is the main mechanism to increase recovery in carbonate formations by low-salinity water flooding. Others have experimental results showing improved oil recovery during low-salinity waterflood in carbonate reservoirs. Their experiments were conducted with live oil both at ambient and high temperatures (90° C.). Zahid et al. “Experimental Studies of Low Salinity Water Flooding Carbonate: A New Promising Approach,” SPE 155625, presented at the SPE EOR Conference at Oil and Gas West Asia, Muscat, Oman, Apr. 16-18, 2012. It was also observed no effect of low salinity waterflooding on oil recovery at ambient temperature. However, an increase in oil recovery was observed with runs at high temperatures (90° C.). Moreover, due to the increase in pressure drop, migration of fines or dissolution effects may have occurred and may contribute to the increase in oil recovery.

### SUMMARY OF THE INVENTION

The present invention relates to a method to enhance oil recovery using a surfactant-augmented, low-salinity waterflood. The surfactant-augmented low-salinity water is utilized following a high salinity water injection and at least one low-salinity water injection in the oil reservoir. Following the low-salinity waterflood, the present invention utilizes a surfactant diluted in low-salinity water. In some embodiments, low salinity waterflooding and the surfactant diluted in low salinity water injections may be alternated into the reservoir to effectively mobilize additional residual oil reservoirs.

Oil production and ultimately oil recovery is improved by injecting low-salinity water into an oil reservoir that has previously undergone a high salinity water injection. However, both the production rate and ultimate oil recovery can be improved further by injecting surfactant-augmented low-salinity water after the low-salinity water injection. Any suitable surfactant may be used, but preferably the surfactant is non-ionic, such as an ethoxylated alcohol, at low concentrations (e.g., about 1,000 ppm to about 5,000 ppm). Non-ionic surfactants perform well in low-salinity brine and mobilize substantial residual oil when the low-salinity water is followed by surfactant diluted in low-salinity water.

A nonionic surfactant used in the presence of a moderate salinity water increases oil recovery in carbonate reservoirs. However, reservoirs are usually high saline environments. During seawater flooding, the salinity of reservoirs decreases but not low enough to be favorable for surfactant flooding. Due to this fact, the success of chemical EOR in general and a nonionic surfactant for field application has been limited. The seawater flooding will reduce the salinity of the reservoir formation water but will not be favorable enough for surfactant flooding yet; but the three sets of low-salinity waterflood will further reduce the salinity to be favorable for ethoxylated alcohol surfactant flooding.

The advantage of the present invention is that the salinity of the environment will be lowered due to the low-salinity waterflood prior to the surfactant augmented low-salinity water flooding, especially when the waterflood uses a high salinity water, such as seawater, in offshore environment. Low-salinity water injected into carbonate reservoirs, which have undergone seawater injection for water flooding, may produce additional oil more economically if a surfactant, (by way of example only, a low-concentration non-ionic surfactant), is added to the low-salinity water and injected as chase fluid. This process may be implemented as low-salinity water flooding—alternating—surfactant augmented in low-salinity water flooding scheme as well. Though not wanting to be bound by theory, it is believed that:
i. Full field low salinity water injection is expensive because it has to displace the already injected seawater to be beneficial. This takes a long time to reach the beneficial effects.
ii. Surfactant flooding is effective only in low-salinity environment.
iii. This process may be implemented as an alternating low-salinity-surfactant system to improve economics.

The concentration of surfactant diluted in low-salinity water may be between about 500 ppm to 10,000 ppm. Hence, the surfactant will be effective in mobilizing residual oil.

By way of example, this EOR process can be applied to one of the largest carbonate reservoir, Upper Zakum, located offshore Abu Dhabi. This reservoir is currently undergoing conventional seawater flooding at injection rate of 800 MBW/day. The average daily oil production is about 560 MSTB. The surfactant with low-salinity water EOR process described herein can have a potential impact to improve ultimate recovery of the field.

An aspect of the invention is a method to enhance recovery of oil in a hydrocarbon reservoir. The method includes injecting low-salinity water into the reservoir. The low-salinity water injection is followed by an injection of a surfactant diluted in an additional low salinity water. The salinity of the additional low-salinity water is less than the salinity of the low-salinity water.

Another aspect of the invention is a method to enhance oil recovery from a hydrocarbon reservoir. The method includes injecting a high salinity water into the reservoir. The injection of the high salinity water is followed by an injection of a low salinity water into the reservoir. The salinity of the low salinity water is less than a salinity level of the high salinity water. Following the low salinity water injection, a lower salinity water into the reservoir. The salinity level of the lower is less than the salinity of the low salinity water. An injection with a surfactant diluted in the lower salinity water is injected into the reservoir next. The injection of the lower salinity water and the surfactant in the lower salinity water into the reservoir are successively injected into the reservoir.

An aspect of the invention is a method to enhance recovery of a hydrocarbon in a reservoir. The method includes waterflooding the reservoir with high salinity water. Low salinity water is injected into the reservoir, where at least about 0.2 of pore volume of the reservoir is occupied by the low salinity water. A surfactant diluted in a low salinity water is next injected into the reservoir. At least about 0.2 of the pore volume of the reservoir is occupied by the surfactant diluted in the additional low salinity water. Additional injections of the low salinity water and the surfactant diluted in the additional low salinity water into the reservoir are successively injected into the reservoir.

### BRIEF DESCRIPTION OF THE DRAWING

FIG. 1 illustrates the petrophysical model of a reservoir showing gamma ray, porosity, and permeability log for three formations;

FIG. 2 illustrates the petrography of geologic facies 5A and C of cores used in the experiments;

FIG. 3 illustrates the pore size distribution for FA and FC. For FA, the pore sizes are distributed between <5 μm to 70 μm with the majority is less than 10 μm. For FC, the pore sizes are distributed between <5 μm to 70 μm with primarily between 5 to 10 μm. See Jobe (2013);

FIG. 4 illustrates a summary of the experimental procedure;

FIG. 5 illustrates a composite core from FC was formed by combining the three cores using the Huppler technique;

FIG. 6 illustrates a schematic diagram of the low salinity waterflooding followed by surfactant diluted in low-salinity waterflooding process and core flooding experiment set up;

FIG. 7 illustrates the oil recovery factor (RF) and pressure drop across the core (ΔP) as a function pore volume injected during the different floods (seawater flood (WF), the three sets of low-salinity waterflood [LS₁, LS₂, and LS₃], and the ten PV non-ionic surfactant flood diluted in LS₂ fluid);

FIG. 8 illustrates the oil recovery factor and AP across the core as a function pore volume injected during the different floods (seawater flood (WF), the three sets of low-salinity waterflood [LS₁, LS₂, and LS₃], and the five PV non-ionic surfactant flood diluted in LS₂ fluid);

FIG. 9 illustrates cleaned un-aged and crude-aged carbonate discs of FA used for contact angle measurements;

FIG. 10A illustrates a contact angle of about 20.9 degrees between cleaned un-aged carbonate core discs and oil-droplets in about 102,692 ppm salinity brine with 1,000 ppm surfactant for FA (also discussed in Table 5 as Sample A);

FIG. 10B illustrates a contact angle of about 17.6 degrees between cleaned un-aged carbonate core discs and oil-droplets in about 92,423 ppm salinity brine with 1,000 ppm surfactant for FA (also discussed in Table 5 as Sample B);

FIG. 10C illustrates a contact angle of about 15 degrees between cleaned un-aged carbonate core discs and oil-droplets in about 51,346 ppm salinity brine with 1,000 ppm surfactant for FA (also discussed in Table 5 as Sample C);

FIG. 10D illustrates a contact angle of about 12.3 degrees between cleaned un-aged carbonate core discs and oil-droplets in about 25,679 ppm salinity brine with 1,000 ppm surfactant for FA (also discussed in Table 5 as Sample D);

FIG. 10E illustrates a contact angle of about 5.4 degrees between cleaned un-aged carbonate core discs and oil-droplets in about 1,027 ppm salinity brine with 1,000 ppm surfactant for FA (also discussed in Table 5 as Sample E);

FIG. 10F illustrates a contact angle of about 4.8 degrees between cleaned un-aged carbonate core discs and oil-droplets in about 0 ppm salinity brine with 1,000 ppm surfactant for FA (also discussed in Table 5 as Sample F);

FIG. 11A illustrates a contact angle of about 72.4 degrees between crude-aged carbonate core discs and oil-droplets in about 100,000 ppm salinity brine with 1,000 ppm surfactant for FA (also discussed in Table 6 as Sample A);

FIG. 11B illustrates a contact angle of about 62.0 degrees between crude-aged carbonate core discs and oil-droplets in about 51,346 ppm salinity brine with 1,000 ppm surfactant for FA (also discussed in Table 6 as Sample B);

FIG. 11C illustrates a contact angle of about 56.0 degrees between crude-aged carbonate core discs and oil-droplets in about 25,679 ppm salinity brine with 1,000 ppm surfactant for FA (also discussed in Table 6 as Sample C);

FIG. 11D illustrates a contact angle of about 51.0 degrees between crude-aged carbonate core discs and oil-droplets in about 12,840 ppm salinity brine with 1,000 ppm surfactant for FA (also discussed in Table 6 as Sample D);

FIG. 11E illustrates a contact angle of about 47.0 degrees between crude-aged carbonate core discs and oil-droplets in about 1,027 ppm salinity brine with 1,000 ppm surfactant for FA (also discussed in Table 6 as Sample E);

FIG. 11F illustrates a contact angle of about 41.7 degrees between crude-aged carbonate core discs and oil-droplets in about 0 ppm salinity brine with 1,000 ppm surfactant for FA (also discussed in Table 6 as Sample F);

FIG. 12 illustrates contact angles between crude-aged carbonate core discs and oil-droplets in variable salinity brine (Samples A-F) with 1,000 ppm surfactant for FA;

FIG. 13A illustrates a contact angle of about 95.0 between crude-aged carbonate core discs and oil-droplets in about 100,000 ppm salinity brine with 1,000 ppm surfactant for FC (also discussed in Table 7 as Sample A);

FIG. 13B illustrates a contact angle of about 87.8 between crude-aged carbonate core discs and oil-droplets in about 51,346 ppm salinity brine with 1,000 ppm surfactant for FC (also discussed in Table 7 as Sample B);

FIG. 13C illustrates a contact angle of about 77.0 between crude-aged carbonate core discs and oil-droplets in about 25,679 ppm salinity brine with 1,000 ppm surfactant for FC (also discussed in Table 7 as Sample C);

FIG. 13D illustrates a contact angle of about 68.1 between crude-aged carbonate core discs and oil-droplets in about 12,840 ppm salinity brine with 1,000 ppm surfactant for FC (also discussed in Table 7 as Sample D);

FIG. 13E illustrates a contact angle of about 60.2 between crude-aged carbonate core discs and oil-droplets in about 1,027 ppm salinity brine with 1,000 ppm surfactant for FC (also discussed in Table 7 as Sample E);

FIG. 13F illustrates a contact angle of about 53.1 between crude-aged carbonate core discs and oil-droplets in about 0 ppm salinity brine with 1,000 ppm surfactant for FC (also discussed in Table 7 as Sample F); and

FIG. 14 illustrates measurements of IFT between oil-droplets and for variable salinity levels without surfactants

### DETAILED DESCRIPTION

The present invention relates to methods to recover oil from a reservoir. An aspect of the invention relates to a method to recover oil from a reservoir, which includes injecting high salinity water into the reservoir followed by alternating the injection of low salinity water and surfactant diluted in low salinity water. Another aspect of the invention includes a method for the enhanced recovery of oil from a reservoir where oil had previously been recovered.

As provided herein, the abbreviations as used within this patent application has the following meanings:

“High salinity water” means a higher salinity level in water compared to a salinity level in low salinity water. By way of example only, high salinity water may be seawater, formation water, produced water and combinations thereof. High salinity water also includes within its definition the term waterflooding as it is generally known in the art as in typical operations. “Low salinity water” means water with a lower salinity level compared to the salinity level in a high salinity water. By way of example only, high salinity water may be seawater, while low salinity water may be desalinated seawater. Other examples of low salinity water may include, but are not limited to, at least one of desalinated seawater, diluted seawater, desalinated hydrocarbon reservoir formation water, diluted hydrocarbon reservoir water, river water, lake water, or formation water. Alternatively, low salinity water may be seawater, while high salinity water may be water with a higher salinity than the seawater. Thus, high salinity water is defined by the comparison to the low salinity water, and vice versa.
“LS₂” generally means low salinity where the salinity level is lower than the high salinity water (for example the seawater) by a factor of about 4. This low-salinity water can be prepared by a dilution or desalination processes.
“LS₃” generally means low salinity where the salinity level is lower than the high salinity water (for example the seawater) by a factor of about 50. This low-salinity water can be prepared by a dilution or desalination processes.
“LSₓ” generally means low salinity where the salinity level is lower than the high salinity water (for example the seawater) by a factor of about “y” (where y may be equal to x). This low-salinity water can be prepared by a dilution or desalination processes.
“PV” generally means pore volume.
“SW” generally means seawater.
“IFT” generally means interfacial tension.
“TDS” generally means total dissolved solids.
“Water cut” generally means the percentage or fraction of water compared to the oil produced during production.

One skilled in the art would understand that the operating conditions of the reservoir will depend upon the characteristics of the reservoir. Thus, the temperature, flow rate of the high salinity water, flow rate of the low salinity water, flow rate of the surfactant diluted in the low salinity water, duration of the high salinity waterflood, duration of the low salinity waterflood, duration of the surfactant diluted in the low salinity water injection (which may be measured by the pore volume injected), the water cut and other operating parameters may not be discussed. However, one skilled in the art would understand how to determine the operating parameters for a particular reservoir.

An aspect of the present invention is a method to enhance the recovery of oil in a hydrocarbon reservoir. The method includes injecting low-salinity water into the reservoir followed by an injection of surfactant diluted in an additional low salinity water, wherein the salinity of surfactant diluted in the additional low-salinity water is at most the salinity of the low-salinity water.

The method may further include a high salinity waterflood prior to the low salinity water injection. The salinity of the high salinity water may be between about 35,000 ppm and about 60,000 ppm TDS, in some embodiments between about 40,000 ppm and about 50,000 ppm TDS.

The low salinity water may be high salinity water that has been desalinated or diluted. Furthermore, the low-salinity water may be further diluted and injected into the reservoir following an injection with low-salinity water. This lower-salinity water injection may be followed with a low-salinity water injection where the salinity level may be the same as a prior low salinity water injection, or lower than a previous low salinity water injection. By way of non-limiting example, the low salinity water may be at least one of desalinated seawater, diluted seawater, desalinated hydrocarbon reservoir formation water, diluted hydrocarbon reservoir water, river water, lake water, or produced hydrocarbon reservoir water. In some embodiments, the salinity of a subsequent low-salinity water flood may have a salinity level that may be within about 75% of the salinity level of a prior low-salinity flood. Low-salinity waterflooding may be repeated until the yield of oil from the reservoir may be less than about 40%, less than about 35%, less than about 30%, less than about 25%, less than about 20%, less than about 15%, less than about 10% or less than about 5%.

The surfactant may be added to low-salinity water. By way of example, the surfactant may be diluted in low salinity water that may have the same or lower salinity level as a prior injection of the low salinity water.

In some embodiments, the low salinity water injection and the surfactant diluted in the additional low salinity water may be alternated. The low salinity water injection and the surfactant diluted in the additional low-salinity water may be alternated until the water cut may be greater than about 60%, greater than about 65%, greater than about 70%, greater than about 75%, greater than about 80%, greater than about 85%, greater than about 90% and greater than about 95%.

In some embodiments, the method may further include an injection of lower-salinity water following the low-salinity water injection. The salinity of the lower-salinity water may be less than the salinity of the low-salinity water. The method may further include alternating the injection of the lower-salinity water and the surfactant diluted in the lower-salinity water. The alternation of the lower salinity water and the surfactant diluted in the lower-salinity water may be repeated until the water cut may be greater than about 60%, greater than about 65%, greater than about 70%, greater than about 75%, greater than about 80%, greater than about 85%, greater than about 90% and greater than about 95%. Alternatively, the alternation of the lower salinity water and the surfactant diluted in the lower-salinity water may be repeated until the incremental oil recovery may be less than about 50%, about 40%, about 30%, about 20%, about 10%, or about 5%.

The surfactant may be any suitable surfactant. Surfactants are surface-acting agents that reduce the interfacial tension (IFT) between brine and oil. Surfactants are classified according the ionic nature of the head group as anionic, cationic, and non-ionic. Anionic surfactants are mostly used in enhanced oil recovery for sandstone reservoirs. Suitable anionic include, but are not limited to, surfactants that include sulfonate or a sulfonate group, such as sodium laureth sulfate, ammonium lauryl sulfate, dioctyl sodium sulfosuccinate, perfluorobutanesulfonic acid, perfluorononanoic acid, perfluorooctanesulfonic acid, perfluorooctanoic acid, potassium lauryl sulfate, sodium dodecyl sulfate, sodium dodecyl benzene sulfonate, sodium lauroyl sarcosinate, sodium myreth sulfate, sodium pareth sulfate, sodium stearate, soaps, alkyl sulfate, alkyl ether sulfates, sulfated alkanolamides, glyceride sulfates, dodecyl benzene sulfonate, alpha olefin sulfonates, lignosulfonates, the like and combinations thereof. Non-ionic surfactants serve as co surfactants in order to improve the system phase behavior. Due to a better tolerance of non-ionic surfactant to salinity, anionic and non-ionic surfactants are sometimes used as a mixture of surfactants to enhance oil recovery. Carbonate reservoirs are usually oil-wet reservoirs, hence the recovery during seawater flooding is not efficient and requires surface-acting agents to alter the wettability and improve oil recovery. Cationic surfactants are sometimes used in carbonate reservoirs to alter wettability, but they are costly.

In some embodiments, the surfactant may be a nonionic surfactant. The nonionic surfactant can be at least one of ethoxylated alcohol, polyoxyethylene glycol alkyl ether, octaethylene glycol monododecyl ether, pentaethylene glycol monododecyl ether, polyoxypropylene glycol alkyl ether, glucoside alkyl ether, decyl glucoside, lauryl glucoside, octyl glucoside, polyoxyethylene glycol octylphenol ether, triton X-100, polyoxyethylene glycol alkylphenol ether, nonoxynol-9, glycerol alkyl esters, glyceryl laurate, polyoxyethylene glycol sorbitan alkyl esters, polysorbate, sorbitan alkyl esters, spans, cocamide MEA, cocamide DEA, dodecyldimethylamine oxide, block copolymers of polyethylene glycol, polypropylene glycol, or a poloxamer. The nonionic surfactant may preferably be ethoxylated alcohol, which may applicable to reservoir conditions.

The concentration of the surfactant in low salinity water (where the salinity level of the low salinity water may be the same or less than the salinity level of a prior low-salinity water injection) may be between about 500 ppm to 10,000 ppm, in some embodiments between about 1,000 ppm and about 5,000 ppm. The concentration of the surfactant in the low-salinity water may be about 1,000 ppm, about 1,500 ppm, about 2,000 ppm, about 2,500 ppm, about 3,000 ppm, about 3,500 ppm, about 4,000 ppm, about 4,500 ppm, or about 5,000 ppm.

As described in the definitions, the salinity level of the low salinity water is less than the salinity level of the high salinity water. The low salinity water may be formed by decreasing the salinity level of the high salinity water to form the low salinity water. By way of example the high salinity water may be decreased by desalinating the high salinity water. In some embodiments, the salinity level of the low salinity water can be half the salinity level of the high salinity water. In some embodiments, the salinity level of the low salinity water can be twenty-five percent of the salinity level of the high salinity water. In some embodiments, the low salinity water can be “x” times the salinity level of the high salinity water, where x is the amount the salinity is decreased compared to the high salinity water. The benefits of the present invention may be increased when the salinity in the low salinity water is decreased. Thus, in a preferred embodiment, the low salinity water may be fresh water, though it is understood that the use of fresh water may be constricted by economic factors. Furthermore, the salinity of the low salinity water may be the same or altered with each subsequent injection. Thus, by way of example only, the salinity level of the first low salinity water injection may be about LS₂, which the salinity level of the second low salinity water injection may be LS₃, then the salinity of the third low salinity water injection may be LS₄.

The pore volume of the reservoir may be occupied by the low salinity water injected into the reservoir, subsequent low-salinity water injections, or injections of the surfactant diluted in the low-salinity water, may be dependent upon the reservoir. In some embodiments, the pore volume of the reservoir occupied by the low salinity water injected into the reservoir, subsequent low-salinity water injections, or injections of the surfactant diluted in the low-salinity water into the reservoir, may be about 1 (i.e. about 100%). In some embodiments, the pore volume of the reservoir occupied by the low salinity water injected into the reservoir, subsequent low-salinity water injections, or injections of the surfactant diluted in the low-salinity water may be greater than about 0.1, about 0.2, about 0.3, about 0.4, about 0.5, about 0.6, about 0.7, about 0.8, about 0.9 or about 1. In some embodiments, the pore volume of the first low salinity water injection may be less than or equal to the pore volume of subsequent low salinity water injections (including low salinity water injections with surfactant). In some embodiments where the high salinity water was injected first, the pore volume of the reservoir of the low salinity water may be about 1, such that the majority or all of the high salinity water that was injected into the reservoir may be displaced by the low salinity water. In some embodiments, the pore volume of the first surfactant diluted in low salinity water injection may be higher than the pore volume of subsequent surfactant diluted in low salinity water injections. In some embodiments, the pore volume of the first surfactant diluted in low salinity water injection may be the same or less than the pore volume of subsequent surfactant diluted in low salinity water injections. In some embodiments, the pore volume of the surfactant diluted in low salinity water may be the same or different from the low salinity water injections.

A slug size or slug may be used to characterize the relationship between the low salinity water injection and surfactant diluted in low salinity water injection. Slug may be defined as a pore volume of the surfactant diluted in low-salinity water injected. The slug may be lower than about 0.1 PV. In some embodiments, the slug may be between 0.1 PV to about 1 PV, in some embodiments, between about 0.1 PV to about 0.5 PV. In some embodiments, the slug can be alternated in a slug size of about 0.5 pore volume. In some embodiments, the low salinity water injection may be alternated in a slug size of about 0.1 to about 1 pore volume.

The method may be used to recover oil from an oil reservoir. In some embodiments, the oil reservoir may be an oil-wet carbonate reservoir, a shale reservoir or a sandstone reservoir. One skilled in the art would understand that the reservoir may comprise a single reservoir or multiple reservoirs, or a single well or multiple wells. The reservoir may be offshore or onshore. The oil recovered may be at least crude oil.

An aspect of the present invention is a method to enhance oil recovery from a hydrocarbon reservoir. The method includes injecting high salinity water into the reservoir, then injecting low salinity water into the reservoir following the injection of the high salinity water. The salinity level of the low salinity water is less than a salinity level of the high salinity water. Lower salinity water can be injected into the reservoir following the injection of the low salinity water. The salinity level of the lower salinity water is less than the salinity of the low salinity water. A surfactant diluted in the lower salinity water into the reservoir is then injected into the reservoir. Then, injections of the low salinity water and the surfactant diluted in the low salinity water are then alternated.

The salinity of the high salinity water may be between about 35,000 ppm and about 60,000 ppm TDS, in some embodiments between about 40,000 ppm and about 50,000 ppm TDS.

The low salinity water may be high salinity water that has been desalinated or diluted. Furthermore, the low-salinity water may be further diluted and injected into the reservoir following an injection with low-salinity water. This lower-salinity water injection may be followed with a low-salinity water injection where the salinity level may be the same as a prior low salinity water injection, or lower than a previous low salinity water injection. By way of non-limiting example, the low salinity water may be at least one of desalinated seawater, diluted seawater, desalinated hydrocarbon reservoir formation water, diluted hydrocarbon reservoir water, river water, lake water, or produced hydrocarbon reservoir water. In some embodiments, the salinity of a subsequent low-salinity water flood may have a salinity level that may be within about 75% of the salinity level of a prior low-salinity flood. Low-salinity waterflooding may be repeated until the yield of oil from the reservoir may be less than about 40%, less than about 35%, less than about 30%, less than about 25%, less than about 20%, less than about 15%, less than about 10% or less than about 5%.

The surfactant may be added to low-salinity or water. By way of example, the surfactant may be diluted in low salinity water that may have the same or lower salinity level as a prior injection of the low salinity water.

In some embodiments, the low salinity water injection and the surfactant diluted in the additional low salinity water may be alternated. The low salinity water injection and the surfactant diluted in the additional low-salinity water may be alternated until the water cut may be greater than about 60%, greater than about 65%, greater than about 70%, greater than about 75%, greater than about 80%, greater than about 85%, greater than about 90% and greater than about 95%.

In some embodiments, the method may further include an injection of lower-salinity water following the low-salinity water injection. The salinity of the lower-salinity water may be less than the salinity of the low-salinity water. The method may further include alternating the injection of the lower-salinity water and the surfactant diluted in the lower-salinity water. The alternation of the lower salinity water and the surfactant diluted in the lower-salinity water may be repeated until the water cut may be greater than about 60%, greater than about 65%, greater than about 70%, greater than about 75%, greater than about 80%, greater than about 85%, greater than about 90% and greater than about 95%. Alternatively, the alternation of the lower salinity water and the surfactant diluted in the lower-salinity water may be repeated until the incremental oil recovery may be less than about 50%, about 40%, about 30%, about 20%, about 10%, or about 5%.

The surfactant may be any suitable surfactant. Surfactants are surface-acting agents that reduce the IFT between brine and oil. Surfactants are classified according the ionic nature of the head group as anionic, cationic, and non-ionic. Anionic surfactants are mostly used in enhanced oil recovery for sandstone reservoirs. Suitable anionic include, but are not limited to, surfactants that include sulfonate or a sulfonate group, such as sodium laureth sulfate, ammonium lauryl sulfate, dioctyl sodium sulfosuccinate, perfluorobutanesulfonic acid, perfluorononanoic acid, perfluorooctanesulfonic acid, perfluorooctanoic acid, potassium lauryl sulfate, sodium dodecyl sulfate, sodium dodecyl benzene sulfonate, sodium lauroyl sarcosinate, sodium myreth sulfate, sodium pareth sulfate, sodium stearate, soaps, alkyl sulfate, alkyl ether sulfates, sulfated alkanolamides, glyceride sulfates, dodecyl benzene sulfonate, alpha olefin sulfonates, lignosulfonates, the like and combinations thereof. Non-ionic surfactants serve as co surfactants in order to improve the system phase behavior. Due to a better tolerance of non-ionic surfactant to salinity, anionic and non-ionic surfactants are sometimes used as a mixture of surfactants to enhance oil recovery. Carbonate reservoirs are usually oil-wet reservoirs, hence the recovery during seawater flooding is not efficient and requires surface-acting agents to alter the wettability and improve oil recovery. Cationic surfactants are sometimes used in carbonate reservoirs to alter wettability, but they are costly.

In some embodiments, the surfactant may be a nonionic surfactant. The nonionic surfactant can be at least one of ethoxylated alcohol, polyoxyethylene glycol alkyl ether, octaethylene glycol monododecyl ether, pentaethylene glycol monododecyl ether, polyoxypropylene glycol alkyl ether, glucoside alkyl ether, decyl glucoside, lauryl glucoside, octyl glucoside, polyoxyethylene glycol octylphenol ether, triton X-100, polyoxyethylene glycol alkylphenol ether, nonoxynol-9, glycerol alkyl esters, glyceryl laurate, polyoxyethylene glycol sorbitan alkyl esters, polysorbate, sorbitan alkyl esters, spans, cocamide MEA, cocamide DEA, dodecyldimethylamine oxide, block copolymers of polyethylene glycol and polypropylene glycol, or poloxamers. Preferably, ethoxylated alcohol may be a used as the surfactant.

The concentration of the surfactant in low salinity water (where the salinity level of the low salinity water may be the same or less than the salinity level of a prior low-salinity water injection) may be between about 500 ppm to 10,000 ppm, in some embodiments between about 1,000 ppm and about 5,000 ppm. The concentration of the surfactant in the low-salinity water may be about 1,000 ppm, about 1,500 ppm, about 2,000 ppm, about 2,500 ppm, about 3,000 ppm, about 3,500 ppm, about 4,000 ppm, about 4,500 ppm, or about 5,000 ppm.

As described in the definitions, the salinity level of the low salinity water is less than the salinity level of the high salinity water. The low salinity water may be formed by decreasing the salinity level of the high salinity water to form the low salinity water. By way of example the high salinity water may be decreased by desalinating the high salinity water. In some embodiments, the salinity level of the low salinity water can be half the salinity level of the high salinity water. In some embodiments, the salinity level of the low salinity water can be twenty-five percent of the salinity level of the high salinity water. In some embodiments, the low salinity water can be “x” times the salinity level of the high salinity water, where x is the amount the salinity is decreased compared to the high salinity water. The benefits of the present invention may be increased when the salinity in the low salinity water is decreased. Thus, in a preferred embodiment, the low salinity water may be fresh water, though it is understood that the use of fresh water may be constricted by economic factors. Furthermore, the salinity of the low salinity water may be the same or altered with each subsequent injection. Thus, by way of example only, the salinity level of the first low salinity water injection may be about LS₂, which the salinity level of the second low salinity water injection may be LS₃, then the salinity of the third low salinity water injection may be LS₄.

The pore volume of the reservoir may be occupied by the low salinity water injected into the reservoir, subsequent low-salinity water injections, or injections of the surfactant diluted in the low-salinity water, may be dependent upon the reservoir. In some embodiments, the pore volume of the reservoir occupied by the low salinity water injected into the reservoir, subsequent low-salinity water injections, or injections of the surfactant diluted in the low-salinity water into the reservoir, may be about 1 (i.e. about 100%). In some embodiments, the pore volume of the reservoir occupied by the low salinity water injected into the reservoir, subsequent low-salinity water injections, or injections of the surfactant diluted in the low-salinity water may be greater than about 0.1, about 0.2, about 0.3, about 0.4, about 0.5, about 0.6, about 0.7, about 0.8, about 0.9 or about 1. In some embodiments, the pore volume of the first low salinity water injection may be less than or equal to the pore volume of subsequent low salinity water injections (including low salinity water injections with surfactant). In some embodiments where the high salinity water was injected first, the pore volume of the reservoir of the low salinity water may be about 1, such that the majority or all of the high salinity water that was injected into the reservoir may be displaced by the low salinity water. In some embodiments, the pore volume of the first surfactant diluted in low salinity water injection may be higher than the pore volume of subsequent surfactant diluted in low salinity water injections. In some embodiments, the pore volume of the first surfactant diluted in low salinity water injection may be the same or less than the pore volume of subsequent surfactant diluted in low salinity water injections. In some embodiments, the pore volume of the surfactant diluted in low salinity water may be the same or different from the low salinity water injections.

A slug size or slug may be used to characterize the relationship between the low salinity water injection and surfactant diluted in low salinity water injection. Slug may be defined as a pore volume of the surfactant diluted in low-salinity water injected. The slug may be lower than about 0.1 PV. In some embodiments, the slug may be between 0.1 PV to about 1 PV, in some embodiments, between about 0.1 PV to about 0.5 PV. In some embodiments, the slug can be alternated in a slug size of about 0.5 pore volume. In some embodiments, the low salinity water injection may be alternated in a slug size of about 0.1 to about 1 pore volume.

The method may be used to recover oil from an oil reservoir. In some embodiments, the oil reservoir may be an oil-wet carbonate reservoir, a shale reservoir or a sandstone reservoir. One skilled in the art would understand that the reservoir may comprise a single reservoir or multiple reservoirs, or a single well or multiple wells. The reservoir may be offshore or onshore. The oil recovered may be at least one of crude oil or natural gas.

An aspect of the present invention includes an enhance recovery of a hydrocarbon in a reservoir. The method includes waterflooding the reservoir with high salinity water. The high-salinity waterflood is followed by an injection of low salinity water into the reservoir. A pore volume of at least about 0.2 is occupied by the low salinity water. A surfactant diluted in low salinity water is injected into the reservoir following the low salinity water injection. The pore volume of at least about 0.2 is occupied by the surfactant diluted in the additional low salinity water. The low salinity water injection and the surfactant diluted in the low salinity water may be alternated.

The salinity of the high salinity water may be between about 35,000 ppm and about 60,000 ppm TDS, in some embodiments between about 40,000 ppm and about 50,000 ppm TDS.

The low salinity water may be high salinity water that has been desalinated or diluted. Furthermore, the low-salinity water may be further diluted and injected into the reservoir following an injection with low-salinity water. This lower-salinity water injection may be followed with a low-salinity water injection where the salinity level may be the same as a prior low salinity water injection, or lower than a previous low salinity water injection. By way of non-limiting example, the low salinity water may be at least one of desalinated seawater, diluted seawater, desalinated hydrocarbon reservoir formation water, diluted hydrocarbon reservoir water, river water, lake water, or produced hydrocarbon reservoir water. In some embodiments, the salinity of a subsequent low-salinity water flood may have a salinity level that may be within about 75% of the salinity level of a prior low-salinity flood. Low-salinity waterflooding may be repeated until the yield of oil from the reservoir may be less than about 40%, less than about 35%, less than about 30%, less than about 25%, less than about 20%, less than about 15%, less than about 10% or less than about 5%.

The surfactant may be added to low-salinity water. By way of example, the surfactant may be diluted in low salinity water that may have the same or lower salinity level as a prior injection of the low salinity water.

In some embodiments, the low salinity water injection and the surfactant diluted in the additional low salinity water may be alternated. The low salinity water injection and the surfactant diluted in the additional low-salinity water may be alternated until the water cut may be greater than about 60%, greater than about 65%, greater than about 70%, greater than about 75%, greater than about 80%, greater than about 85%, greater than about 90% and greater than about 95%.

In some embodiments, the method may further include an injection of lower-salinity water following the low-salinity water injection. The salinity of the lower-salinity water may be less than the salinity of the low-salinity water. The method may further include alternating the injection of the lower-salinity water and the surfactant diluted in the lower-salinity water. The alternation of the lower salinity water and the surfactant diluted in the lower-salinity water may be repeated until the water cut may be greater than about 60%, greater than about 65%, greater than about 70%, greater than about 75%, greater than about 80%, greater than about 85%, greater than about 90% and greater than about 95%. Alternatively, the alternation of the lower salinity water and the surfactant diluted in the lower-salinity water may be repeated until the incremental oil recovery may be less than about 50%, about 40%, about 30%, about 20%, about 10%, or about 5%.

The surfactant may be any suitable surfactant. Surfactants are surface-acting agents that reduce the IFT between brine and oil. Surfactants are classified according the ionic nature of the head group as anionic, cationic, and non-ionic. Anionic surfactants are mostly used in enhanced oil recovery for sandstone reservoirs. Suitable anionic include, but are not limited to, surfactants that include sulfonate or a sulfonate group, such as sodium laureth sulfate, ammonium lauryl sulfate, dioctyl sodium sulfosuccinate, perfluorobutanesulfonic acid, perfluorononanoic acid, perfluorooctanesulfonic acid, perfluorooctanoic acid, potassium lauryl sulfate, sodium dodecyl sulfate, sodium dodecyl benzene sulfonate, sodium lauroyl sarcosinate, sodium myreth sulfate, sodium pareth sulfate, sodium stearate, soaps, alkyl sulfate, alkyl ether sulfates, sulfated alkanolamides, glyceride sulfates, dodecyl benzene sulfonate, alpha olefin sulfonates, lignosulfonates, the like and combinations thereof. Non-ionic surfactants serve as co surfactants in order to improve the system phase behavior. Due to a better tolerance of non-ionic surfactant to salinity, anionic and non-ionic surfactants are sometimes used as a mixture of surfactants to enhance oil recovery. Carbonate reservoirs are usually oil-wet reservoirs, hence the recovery during seawater flooding is not efficient and requires surface-acting agents to alter the wettability and improve oil recovery. Cationic surfactants are sometimes used in carbonate reservoirs to alter wettability, but they are costly.

In some embodiments, the surfactant may be a nonionic surfactant. The nonionic surfactant can be at least one of ethoxylated alcohol, polyoxyethylene glycol alkyl ether, octaethylene glycol monododecyl ether, pentaethylene glycol monododecyl ether, polyoxypropylene glycol alkyl ether, glucoside alkyl ether, decyl glucoside, lauryl glucoside, octyl glucoside, polyoxyethylene glycol octylphenol ether, triton X-100, polyoxyethylene glycol alkylphenol ether, nonoxynol-9, glycerol alkyl esters, glyceryl laurate, polyoxyethylene glycol sorbitan alkyl esters, polysorbate, sorbitan alkyl esters, spans, cocamide MEA, cocamide DEA, dodecyldimethylamine oxide, block copolymers of polyethylene glycol and polypropylene glycol, or poloxamers. Preferably, ethoxylated alcohol may be a used as the surfactant.

The concentration of the surfactant in low salinity water (where the salinity level of the low salinity water may be the same or less than the salinity level of a prior low-salinity water injection) may be between about 500 ppm to 10,000 ppm, in some embodiments between about 1,000 ppm and about 5,000 ppm. The concentration of the surfactant in the low-salinity water may be about 1,000 ppm, about 1,500 ppm, about 2,000 ppm, about 2,500 ppm, about 3,000 ppm, about 3,500 ppm, about 4,000 ppm, about 4,500 ppm, or about 5,000 ppm.

As described in the definitions, the salinity level of the low salinity water is less than the salinity level of the high salinity water. The low salinity water may be formed by decreasing the salinity level of the high salinity water to form the low salinity water. By way of example the high salinity water may be decreased by desalinating the high salinity water. In some embodiments, the salinity level of the low salinity water can be half the salinity level of the high salinity water. In some embodiments, the salinity level of the low salinity water can be twenty-five percent of the salinity level of the high salinity water. In some embodiments, the low salinity water can be “x” times the salinity level of the high salinity water, where x is the amount the salinity is decreased compared to the high salinity water. The benefits of the present invention may be increased when the salinity in the low salinity water is decreased. Thus, in a preferred embodiment, the low salinity water may be fresh water, though it is understood that the use of fresh water may be constricted by economic factors. Furthermore, the salinity of the low salinity water may be the same or altered with each subsequent injection. Thus, by way of example only, the salinity level of the first low salinity water injection may be about LS₂, which the salinity level of the second low salinity water injection may be LS₃, then the salinity of the third low salinity water injection may be LS₄.

The pore volume of the reservoir may be occupied by the low salinity water injected into the reservoir, subsequent low-salinity water injections, or injections of the surfactant diluted in the low-salinity water, may be dependent upon the reservoir. In some embodiments, the pore volume of the reservoir occupied by the low salinity water injected into the reservoir, subsequent low-salinity water injections, or injections of the surfactant diluted in the low-salinity water into the reservoir, may be about 1 (i.e. about 100%). In some embodiments, the pore volume of the reservoir occupied by the low salinity water injected into the reservoir, subsequent low-salinity water injections, or injections of the surfactant diluted in the low-salinity water may be greater than about 0.1, about 0.2, about 0.3, about 0.4, about 0.5, about 0.6, about 0.7, about 0.8, about 0.9 or about 1. In some embodiments, the pore volume of the first low salinity water injection may be less than or equal to the pore volume of subsequent low salinity water injections (including low salinity water injections with surfactant). In some embodiments where the high salinity water was injected first, the pore volume of the reservoir of the low salinity water may be about 1, such that the majority or all of the high salinity water that was injected into the reservoir may be displaced by the low salinity water. In some embodiments, the pore volume of the first surfactant diluted in low salinity water injection may be higher than the pore volume of subsequent surfactant diluted in low salinity water injections. In some embodiments, the pore volume of the first surfactant diluted in low salinity water injection may be the same or less than the pore volume of subsequent surfactant diluted in low salinity water injections. In some embodiments, the pore volume of the surfactant diluted in low salinity water may be the same or different from the low salinity water injections.

A slug size or slug may be used to characterize the relationship between the low salinity water injection and surfactant diluted in low salinity water injection. Slug may be defined as a pore volume of the surfactant diluted in low-salinity water injected. The slug may be lower than about 0.1 PV. In some embodiments, the slug may be between 0.1 PV to about 1 PV, in some embodiments, between about 0.1 PV to about 0.5 PV. In some embodiments, the slug can be alternated in a slug size of about 0.5 pore volume. In some embodiments, the low salinity water injection may be alternated in a slug size of about 0.1 to about 1 pore volume.

The method may be used to recover oil from an oil reservoir. In some embodiments, the oil reservoir may be an oil-wet carbonate reservoir, a shale reservoir or a sandstone reservoir. One skilled in the art would understand that the reservoir may comprise a single reservoir or multiple reservoirs, or a single well or multiple wells. The reservoir may be offshore or onshore. The oil recovered may be at least one of crude oil or natural gas.

An aspect of the present invention is a method to enhance the recovery of oil from a reservoir. The method includes injecting seawater into the oil reservoir. The salinity of the seawater is between about 35,000 ppm to about 60,000 ppm TDS. The seawater flood is followed by a low-salinity water injection into the reservoir. The salinity of the low-salinity water is at most about one half of the salinity of the seawater. The lower-salinity water injection follows the low-salinity waterflood. The salinity of the lower-salinity water is at most about a quarter of the salinity of the seawater. Following the lower salinity waterflood, the reservoir is flooded with a surfactant diluted in the lower-salinity water. The lower-salinity flooding and the surfactant diluted in the lower-salinity water are alternated until a water cut is greater than about 60%.

The salinity of the seawater may be between about 35,000 ppm and about 60,000 ppm TDS, in some embodiments between about 40,000 ppm and about 50,000 ppm TDS.

The low salinity water may be seawater that has been desalinated or diluted. Furthermore, the low-salinity water may be further diluted and injected into the reservoir following an injection with low-salinity water. This lower-salinity water injection may be followed with a low-salinity water injection where the salinity level may be the same as a prior low salinity water injection, or lower than a previous low salinity water injection. By way of non-limiting example, the low salinity water may be at least one of desalinated seawater, diluted seawater, desalinated hydrocarbon reservoir formation water, diluted hydrocarbon reservoir water, river water, lake water, or produced hydrocarbon reservoir water. In some embodiments, the salinity of a subsequent low-salinity water flood may have a salinity level that may be within about 75% of the salinity level of a prior low-salinity flood. Low-salinity waterflooding may be repeated until the yield of oil from the reservoir may be less than about 40%, less than about 35%, less than about 30%, less than about 25%, less than about 20%, less than about 15%, less than about 10% or less than about 5%.

The surfactant may be added to low-salinity water. By way of example, the surfactant may be diluted in low salinity water that may have the same or lower salinity level as a prior injection of the low salinity water.

In some embodiments, the low salinity water injection and the surfactant diluted in the additional low salinity water may be alternated. The low salinity water injection and the surfactant diluted in the additional low-salinity water may be alternated until the water cut may be greater than about 60%, greater than about 65%, greater than about 70%, greater than about 75%, greater than about 80%, greater than about 85%, greater than about 90% and greater than about 95%.

In some embodiments, the method may further include an injection of lower-salinity water following the low-salinity water injection. The salinity of the lower-salinity water may be less than the salinity of the low-salinity water. The method may further include alternating the injection of the lower-salinity water and the surfactant diluted in the lower-salinity water. The alternation of the lower salinity water and the surfactant diluted in the lower-salinity water may be repeated until the water cut may be greater than about 60%, greater than about 65%, greater than about 70%, greater than about 75%, greater than about 80%, greater than about 85%, greater than about 90% and greater than about 95%. Alternatively, the alternation of the lower salinity water and the surfactant diluted in the lower-salinity water may be repeated until the incremental oil recovery may be less than about 50%, about 40%, about 30%, about 20%, about 10%, or about 5%.

The surfactant may be any suitable surfactant. Surfactants are surface-acting agents that reduce the interfacial tension (IFT) between brine and oil. Surfactants are classified according the ionic nature of the head group as anionic, cationic, and non-ionic. Anionic surfactants are mostly used in enhanced oil recovery for sandstone reservoirs. Suitable anionic include, but are not limited to, surfactants that include sulfonate or a sulfonate group, such as sodium laureth sulfate, ammonium lauryl sulfate, dioctyl sodium sulfosuccinate, perfluorobutanesulfonic acid, perfluorononanoic acid, perfluorooctanesulfonic acid, perfluorooctanoic acid, potassium lauryl sulfate, sodium dodecyl sulfate, sodium dodecyl benzene sulfonate, sodium lauroyl sarcosinate, sodium myreth sulfate, sodium pareth sulfate, sodium stearate, soaps, alkyl sulfate, alkyl ether sulfates, sulfated alkanolamides, glyceride sulfates, dodecyl benzene sulfonate, alpha olefin sulfonates, lignosulfonates, the like and combinations thereof. Non-ionic surfactants serve as co surfactants in order to improve the system phase behavior. Due to a better tolerance of non-ionic surfactant to salinity, anionic and non-ionic surfactants are sometimes used as a mixture of surfactants to enhance oil recovery. Carbonate reservoirs are usually oil-wet reservoirs, hence the recovery during seawater flooding is not efficient and requires surface-acting agents to alter the wettability and improve oil recovery. Cationic surfactants are sometimes used in carbonate reservoirs to alter wettability, but they are costly.

In some embodiments, the surfactant may be a nonionic surfactant. The nonionic surfactant can be at least one of ethoxylated alcohol, polyoxyethylene glycol alkyl ether, octaethylene glycol monododecyl ether, pentaethylene glycol monododecyl ether, polyoxypropylene glycol alkyl ether, glucoside alkyl ether, decyl glucoside, lauryl glucoside, octyl glucoside, polyoxyethylene glycol octylphenol ether, triton X-100, polyoxyethylene glycol alkylphenol ether, nonoxynol-9, glycerol alkyl esters, glyceryl laurate, polyoxyethylene glycol sorbitan alkyl esters, polysorbate, sorbitan alkyl esters, spans, cocamide MEA, cocamide DEA, dodecyldimethylamine oxide, block copolymers of polyethylene glycol and polypropylene glycol, or poloxamers. Preferably, ethoxylated alcohol may be a used as the surfactant.

The concentration of the surfactant in low salinity water (where the salinity level of the low salinity water may be the same or less than the salinity level of a prior low-salinity water injection) may be between about 500 ppm to 10,000 ppm, in some embodiments between about 1,000 ppm and about 5,000 ppm. The concentration of the surfactant in the low-salinity water may be about 1,000 ppm, about 1,500 ppm, about 2,000 ppm, about 2,500 ppm, about 3,000 ppm, about 3,500 ppm, about 4,000 ppm, about 4,500 ppm, or about 5,000 ppm.

As described in the definitions, the salinity level of the low salinity water is less than the salinity level of the seawater. The low salinity water may be formed by decreasing the salinity level of the seawater to form the low salinity water. By way of example the seawater may be decreased by desalinating the seawater. In some embodiments, the salinity level of the low salinity water can be half the salinity level of the seawater. In some embodiments, the salinity level of the low salinity water can be twenty-five percent of the salinity level of the seawater. In some embodiments, the low salinity water can be “x” times the salinity level of the seawater, where x is the amount the salinity is decreased compared to the seawater. The benefits of the present invention may be increased when the salinity in the low salinity water is decreased. Thus, in a preferred embodiment, the low salinity water may be fresh water, though it is understood that the use of fresh water may be constricted by economic factors. Furthermore, the salinity of the low salinity water may be the same or altered with each subsequent injection. Thus, by way of example only, the salinity level of the first low salinity water injection may be about LS₂, which the salinity level of the second low salinity water injection may be LS₃, then the salinity of the third low salinity water injection may be LS₄.

The pore volume of the reservoir may be occupied by the low salinity water injected into the reservoir, subsequent low-salinity water injections, or injections of the surfactant diluted in the low-salinity water, may be dependent upon the reservoir. In some embodiments, the pore volume of the reservoir occupied by the low salinity water injected into the reservoir, subsequent low-salinity water injections, or injections of the surfactant diluted in the low-salinity water into the reservoir, may be about 1 (i.e. about 100%). In some embodiments, the pore volume of the reservoir occupied by the low salinity water injected into the reservoir, subsequent low-salinity water injections, or injections of the surfactant diluted in the low-salinity water may be greater than about 0.1, about 0.2, about 0.3, about 0.4, about 0.5, about 0.6, about 0.7, about 0.8, about 0.9 or about 1. In some embodiments, the pore volume of the first low salinity water injection may be less than or equal to the pore volume of subsequent low salinity water injections (including low salinity water injections with surfactant). In some embodiments where the seawater was injected first, the pore volume of the reservoir of the low salinity water may be about 1, such that the majority or all of the seawater that was injected into the reservoir may be displaced by the low salinity water. In some embodiments, the pore volume of the first surfactant diluted in low salinity water injection may be higher than the pore volume of subsequent surfactant diluted in low salinity water injections. In some embodiments, the pore volume of the first surfactant diluted in low salinity water injection may be the same or less than the pore volume of subsequent surfactant diluted in low salinity water injections. In some embodiments, the pore volume of the surfactant diluted in low salinity water may be the same or different from the low salinity water injections.

A slug size or slug may be used to characterize the relationship between the low salinity water injection and surfactant diluted in low salinity water injection. Slug may be defined as a pore volume of the surfactant diluted in low-salinity water injected. The slug may be lower than about 0.1 PV. In some embodiments, the slug may be between 0.1 PV to about 1 PV, in some embodiments, between about 0.1 PV to about 0.5 PV. In some embodiments, the slug can be alternated in a slug size of about 0.5 pore volume. In some embodiments, the low salinity water injection may be alternated in a slug size of about 0.1 to about 1 pore volume.

The method may be used to recover oil from an oil reservoir. In some embodiments, the oil reservoir may be an oil-wet carbonate reservoir, a shale reservoir or a sandstone reservoir. One skilled in the art would understand that the reservoir may comprise a single reservoir or multiple reservoirs, or a single well or multiple wells. The reservoir may be offshore or onshore. The oil recovered may be at least one of crude oil or natural gas.

### Examples

The potential of low-salinity waterflooding and surfactant diluted in low-salinity water was investigated using cores from reservoir I cores. Three sets of low-salinity waterfloods were performed following the seawater flood, each with five pore volumes (PV). The fluid for the first low-salinity flood (LS₁) was created by diluting the seawater by a factor of two (25,679 ppm). Similarly LS₂ contains diluted seawater by a factor of 4 (12,840 ppm) and LS₃ contains diluted seawater by a factor of 50 (1,027 ppm). The incremental oil recovery of the first two EOR low-salinity waterfloods are 6.2% and 1.1% respectively. No additional oil was recovered during the third low-salinity waterflood. An additional 5% oil recovery was obtained after the subsequent flood of surfactant diluted in low-salinity water (LS₂). A constant 0.1 cm³/min injection rate was applied to each of the three low-salinity waterfloods and surfactant diluted in low-salinity water

### Setup

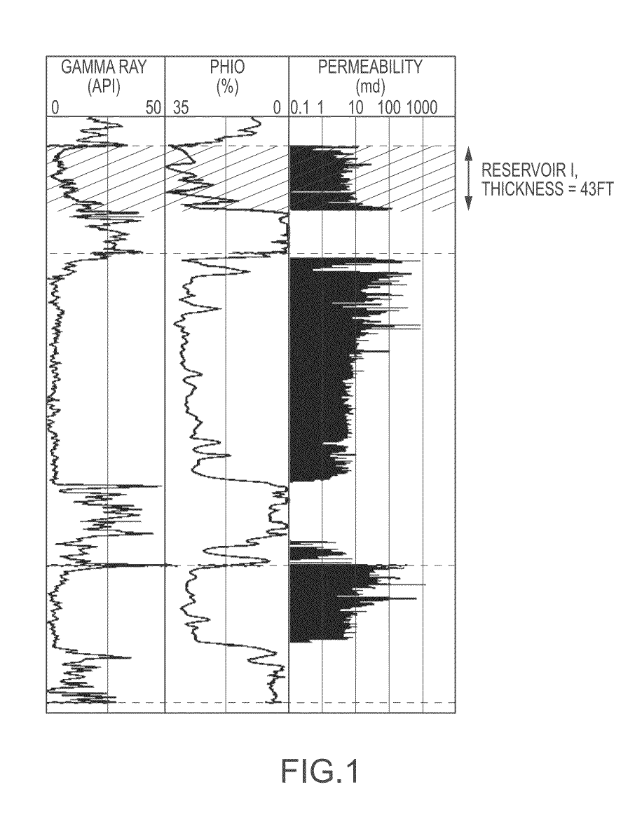

Coreflood experiments were performed using cores from a low-permeability giant carbonate reservoir in the Middle East. The reservoir is subdivided into three main reservoirs: Reservoir I, II, and III. The experiments discussed focus on Reservoir I, which is characterized as fractured with average matrix permeability of about 1.5 md, average porosity of about 24%, and average thickness of about 43 feet as illustrated in FIG. 1 (from Strohmenger et al. “High Resolution Sequence Stratigraphy and Reservoir Characterization of Upper Thamama (Lower Cretaceous) Reservoirs of a Giant Abu Dhabi Oil Field, United Arab Emirates. In: Giant Hydrocarbon Reservoirs of the World: From Rocks to Reservoir Characterization and Modeling (Eds P. M. Harris and L. J. Weber),” AAPG Memoir 88/SEPM Spec. Publ., pp. 139-171 (2006). FIG. 1 illustrates the petrophysical model of a reservoir showing gamma ray, porosity, and permeability log for three formations. The three reservoirs have a combined thickness of about 300 ft and currently is undergoing water injection at 800 MB/day and oil production at 560 MSTB/day. Primary oil production began in 1983 with water injection starting in 1984. The first water breakthrough occurred in 1991. Over the years, water cut has increased from about 5% in the early 1990s to about 24% in 2006. Currently, most of the oil production comes from Reservoir II and III. These two reservoirs have higher permeability compared to Reservoir I.

### Facies of Cores

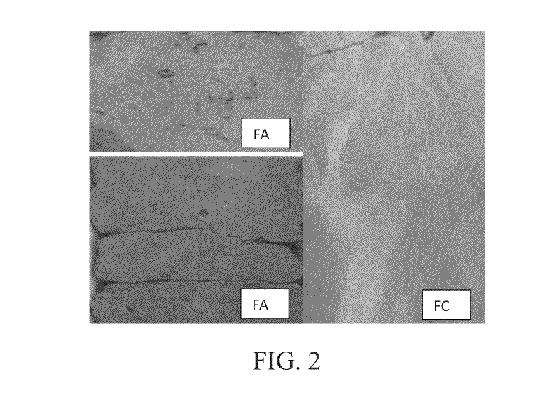

The cores used in coreflood experiments were from two main facies—FA and FC of Reservoir I as illustrated in FIG. 2. FIG. 2 illustrates the petrography of geologic facies 5A and C of cores used in the experiments from Jobe et al. “Sedimentology, Chemostratigraphy and Quantitative Pore Architecture in Microporous Carbonates: Example From A Giant Oil Field Offshore Abu Dhabi,” U.A.E, PhD Thesis, Geology Department, Colorado School of Mines (2013). FA is heterogeneous with dominant micro/macro porosity and heavy oil stains, and the rock texture is Lithocodium-Bacinella boundstone. Abundant Lithocodium-Bacinella echinoderm, coral bivalve skeletal debris, and benthic forams are present in this facies. FC is Lithocodium-Bacinella wackestone with dolomitic burrows. The biotas presented in this facies are abundant oncoidal Lithocodium-Bacinella, and benthic forams. FC also has heavy oil stain with micro/macro/fracture dominant porosity.

### Pore Size Distribution

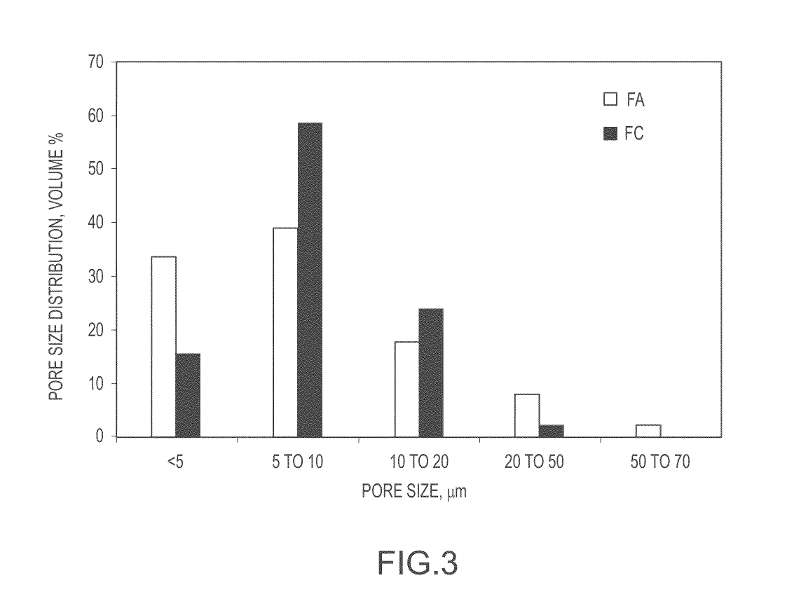

The pore size distribution, in volume percentage, of FA and FC measured using mercury intrusion porosimetry experiments is illustrated in FIG. 3 (Jobe, 2013). FIG. 3 illustrates the pore size distribution for FA and FC. For FA, the pore sizes are distributed between <5 μm to 70 μm with the majority is less than 10 μm. For FC, the pore sizes are distributed between <5 μm to 70 μm with primarily between 5 to 10 μm. See Jobe (2013).

### Laboratory Procedure

Core cleaning, fluid preparation, porosity-permeability measurement: Prior to using the coreflooding, cores were cleaned using the following steps:
1. Cores from Reservoir I (facies A and C) were prepared for cleaning
2. Cores were placed in the Soxhlet extractor with toluene used as the solvent. The Soxhlet extractor was turned off for about 2-3 days to let the cores soak in the toluene. Because the cores are tight, imbibition occurs. If more oil was observed during the last step, the Soxhlet extractor was turned on again. The process of turning on/off the Soxhlet extractor was repeated until no oil was observed. Methanol was then used to remove any salts contaminating in the cores. Finally, toluene was used again in case there was oil trapped behind the salts removed from the cores. The cleaning process was performed until no oil trace is noticed. The approximate time for the cleaning process with toluene was 2 weeks; then one day for methanol, and another one day for toluene.
3. Cores were placed in the oven at about 250° F. for about 24 hours. After drying, the cores were immediately sealed to avoid humidity.
4. Porosity and permeability values of the cores were measured using Core Measurement System CMS 300.
5. Since the cores are tight (about 1-10 mD), the centrifuge plus (ACES 200) equipment was used to saturate the cores with formation brine from Reservoir I.

The formation brine salinity of the reservoir is approximately 100,000 ppm or higher for Reservoir I. The speed was set at between about 3,000-5,000 rpm for about 3 to 4 days to fully saturate the cores and minimize core breakage. The crude oil and formation brine were filtered at about 1.0 microns and about 0.5 microns, respectively. The viscosity values at about 3.0 cp and about 0.535 cp, respectively, were measured at a reservoir temperature of about 195° F. The API gravity of the reservoir oil at standard condition is about 32°. Table 1 is the list of rock properties of the three cores used in the experiment. The diameter of the samples was about 1.5 inches. All values listed in Table 1 are approximate.
6. A synthetic seawater was prepared using the following salts: NaCl, Na₂SO₄, CaCl₂, and MgCl₂. (Zhang and Sarma 2012).

TABLE 1

| | | | | | kₐᵢᵣ | k_{brine} |
|---|---|---|---|---|---|---|
| Ex. # | Facies | L (in) | V (cm³) | Φ (%) | (mD) | (mD) |
| 1 | C | 1.95 | 2.59 | 3.75 | 0.38 | 0.39 |
| | | 1.81 | | 2.71 | 0.81 | |
| | | 1.51 | | 7.36 | 0.70 | |
| 2 | A | 1.643 | 9.21 | 6.94 | 0.38 | 1.34 |
| | | 3.255 | | 4.60 | NA | |
| | | 1.820 | | 0.70 | 0.16 | |
| | | 1.896 | | 4.54 | 0.76 | |

### Coreflood Experiments

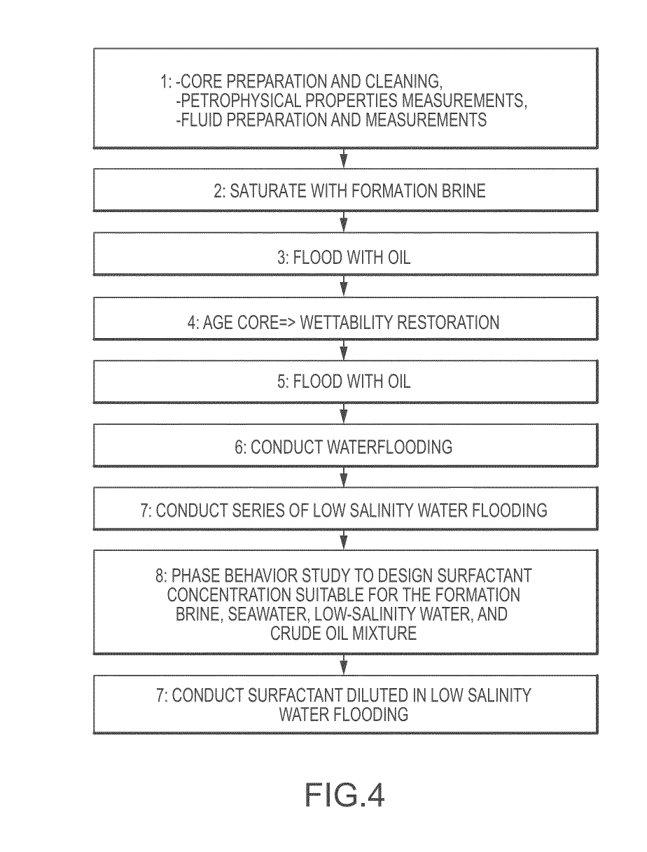

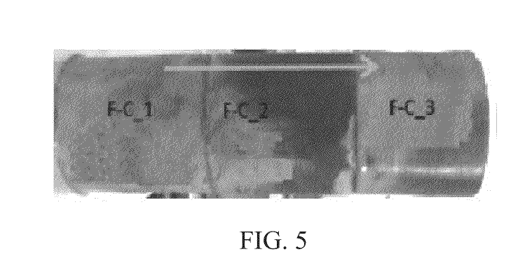

After the cores were saturated with formation brine using centrifuge, the following procedures were followed during the core flooding experiment:
1. Cores were placed in the core holder. A confining pressure of about 2300 psi, a back pressure of about 1800 psi, and reservoir temperature (195° F.) were applied to mimic reservoir conditions.
2. Formation brine was injected at about 0.1 cc/min flow rate to ensure that the cores were still 100% saturated with brine and no air is trapped in the pores. The relative permeability of the core to brine was also determined.
3. Oil was then injected at a flow rate of about 0.1 cc/min until residual water saturation (S_{wi}) was achieved. The oil relative permeability was also determined.
4. To restore wettability, eight weeks of aging was applied for both experiments.
5. Prior to high salinity water injection, about 4 PV oil was injected to mimic oil saturated reservoir condition. Seawater was used as the high salinity water for the experiments.
6. High salinity water was injected to displace the oil at about 0.1 cc/min flow rate. At this point, oil recovery during water flooding, and water relative permeability was determined.
7. After establishing residual oil saturation to high salinity flooding (S_{orw}), brines of different salinities were injected to study the effect of low salinity on incremental oil recovery and wettability alteration. Finally, a slug of nonionic surfactant was injected (ethoxylated alcohol). Oil production, flow rate, pressure drop were recorded and analyzed during the entire core flooding experiment. The summarized experimental procedure applied in this study is illustrated in FIG. 4.
8. After the slug of nonionic surfactant was injected, it may be alternated with the low salinity water without a surfactant.
   The Huppler technique was used in stacking a composite core that contains short cores for both experiments. The technique is simply based on ordering core samples using harmonic average permeability to be close to the average permeability of the composite used. Moreover, the section of the core used that has average permeability close to the overall average permeability should be located at the end of the composite. A composite core from FC was formed by combining the three cores using the Huppler technique as illustrated in FIG. 5. The photograph illustrated in FIG. 5 was taken at the end of the first experiment. The total length of the composite core is about 5.27 inch with a diameter of about 1.5 inch. The stacking was performed using the Huppler technique. The flooding direction is from left to right.

### Experiment 1

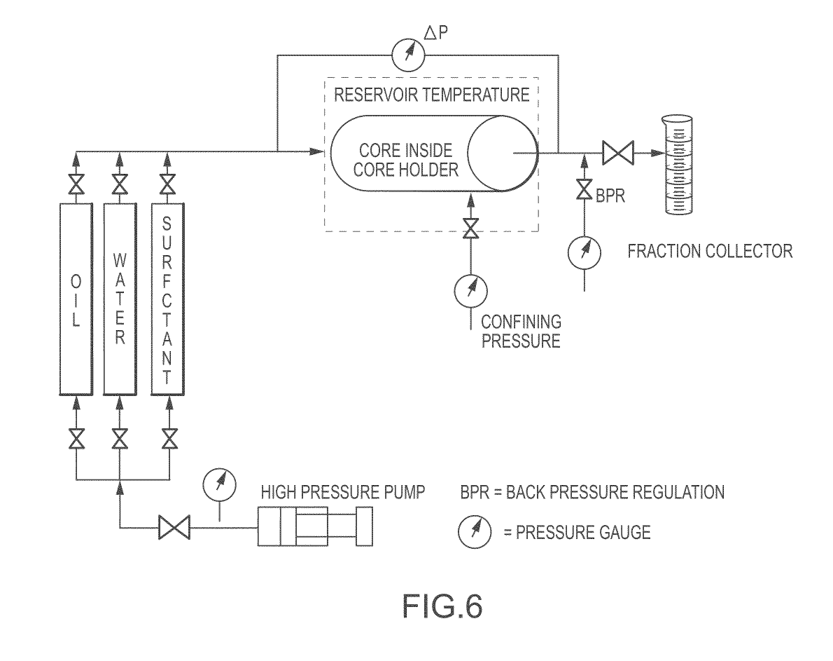

FIG. 6 illustrates a schematic diagram of the low salinity waterflood followed by surfactant diluted in low-salinity waterflooding process and core flooding experiment set up. The production fluid is collected in graduated cylinders using a fraction collector. The graduated tubes are then centrifuged in measure oil production and fluid analysis. For the first experiment, three sets of low-salinity waterfloods were performed following the seawater flood, each with five PV. The fluid for the first low-salinity flood (LS₁) was created by diluting the seawater by a factor of two (about 25,679 ppm). Similarly LS₂ contains diluted seawater by a factor of 4 (about 12,840 ppm) and LS₃ contains diluted seawater by a factor of 50 (about 1,027 ppm). Table 2 illustrates the composition of the seawater (SW) and three sets of low-salinity water (LS₁, LS₂, and LS₃). The incremental oil recovery of the first two EOR low-salinity waterfloods was about 6.2% and about 1.1% respectively. No additional oil was recovered during the third low-salinity waterflood. A constant injection rate of about 0.1 cm³/min was applied to each of the three low-salinity waterfloods.

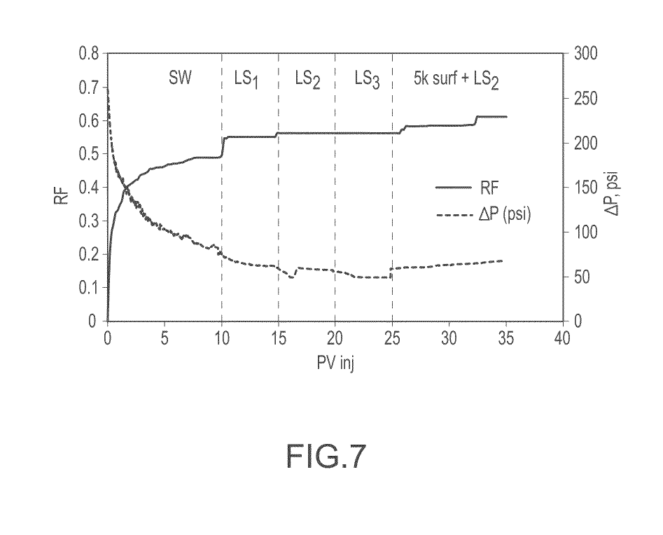

A final flood with ten PV of non-ionic surfactant (about 5,000 ppm) mixed with the LS₂ fluid was performed at about 0.1 cm³/min. After this flood, an incremental oil recovery of about 4.9% was obtained. FIG. 7 illustrates the oil recovery factor and pressure drop across the core (ΔP) as a function pore volume injected during the different floods (seawater flood (WF), the three sets of low-salinity waterflood [LS₁, LS₂, and LS₃], and the non-ionic surfactant flood diluted in LS₂ fluid). FIG. 7 illustrates the oil recovery factor (RF) and pressure difference between injection and production end (ΔP) as a function pore volume injected (PV inj). During waterflooding (WF), 48.9% oil was recovered. During the three sets of low-salinity waterflood (LS₁, LS₂, and LS₃) EOR process, additional 7.3% oil was recovered. Finally during the non-ionic surfactant flood diluted in LS₂, additional 4.9% oil was recovered.

### Experiment 2

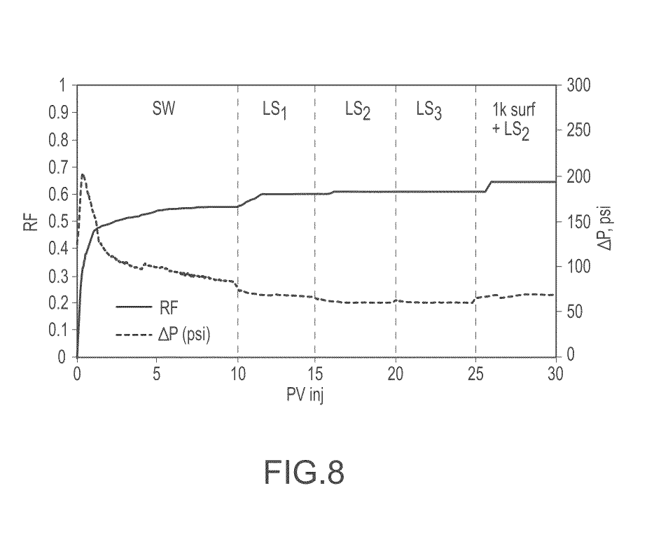

For the second experiment, the same protocol was performed as the first experiment. The incremental oil recovery of the first two EOR low-salinity waterfloods are 4.8% and 0.8% respectively. No additional oil was recovered during the third low-salinity waterflood. A constant injection rate of about 0.1 cm³/min was applied to each of the three low-salinity waterfloods. A final flood with five PV of non-ionic surfactant (about 1,000 ppm) mixed with the LS₂ fluid was performed at a flow rate of about 0.1 cm³/mm. After this flood, an incremental oil recovery of about 4.9% was obtained. FIG. 8 illustrates the oil recovery factor and pressure drop across the core (ΔP) as a function pore volume injected during the different floods (seawater flood (WF), the three sets of low-salinity waterflood [LS₁, LS₂, and LS₃], and the non-ionic surfactant flood diluted in LS₂ fluid). FIG. 8 illustrates the RF and pressure difference between injection and production end (ΔP) as a function pore volume injected (PV inj). During high salinity waterflooding (WF), 55.5% oil was recovered. During the three sets of low-salinity waterflood (LS₁, LS₂, and LS₃) EOR process, additional 5.6% oil was recovered. And finally during the non-ionic surfactant flood diluted in LS₂, additional 3.6% oil was recovered.

During both experiments, it was noted that AP increased during the surfactant flooding period. This increment in AP may be due to adsorption of surfactant. And the increase in AP during the surfactant flood of Experiment 1 (10 PV) was higher than Experiment 2 (5 PV). This might be due to the high concentration of the surfactant (5,000 ppm vs. 1,000 ppm) and high pore volume injected. All values in the Table are approximate.

TABLE 2

| | Compound (kppm) | | | | |
|---|---|---|---|---|---|
| Brine | Na₂SO₄ | CaCl₂ | MgCl₂ | NaCl | TDS |
| SW | 4.891 | 1.915 | 13.550 | 30.99 | 51.346 |
| LS₁ | 2.446 | 0.958 | 6.775 | 15.50 | 25.679 |
| LS₂ | 1.223 | 0.479 | 3.388 | 7.75 | 12.840 |
| LS₃ | 0.098 | 0.038 | 0.271 | 0.620 | 1.027 |

### Experiment 3

### Contact Angle and IFT Measurements

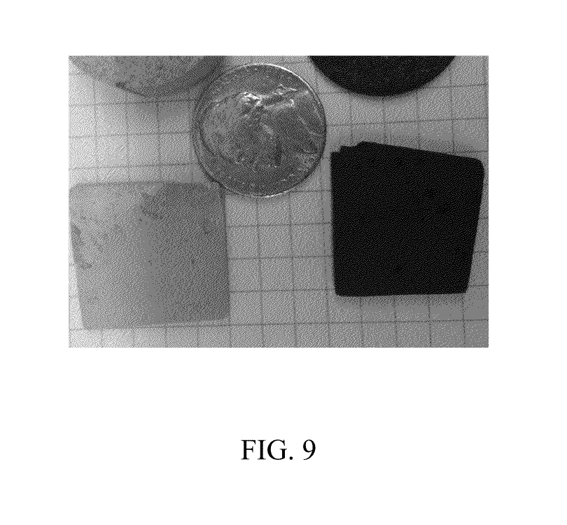

Contact angle and interfacial tension (IFT) measurements were performed with clean un-aged samples, with brines of variable salinities, and brine with at about 1,000 ppm ethoxylated alcohol surfactant for FA and FC. Initially, the core discs were cleaned (as illustrated in FIG. 9) with toluene and methanol and polished them in order to get accurate measurements. Then the core discs were saturated with formation brine using desiccator. The crude-aging was performed by keeping the carbonate discs inside crude oil at reservoir temperature and atmospheric pressure for three weeks for FA, and eight weeks for FC to restore wettability. As an example (Table 3) for FC the un-aged core disc had a contact angle of about 11.0 degrees which indicates strongly water-wet. Cleaning the core changed it from oil-wet to water-wet (illustrated as step 1 in FIG. 4). Table 3 illustrates an example of a contact angle for FC (between cleaned un-aged/aged carbonate core discs and oil-droplets in variable salinity brine injection with/without 1,000 ppm surfactant). All values in the Table are approximate.

TABLE 3

| Contact | Contact | Contact | Contact |
|---|---|---|---|
| angle, θ, in | angle, θ, in | angle, θ, in | angle, θ, in |
| degrees, un-aged | degrees, aged | degrees, aged | degrees, LS₂ + |
| core disc | core disc, seawater | core disc, LS₂ | surfactant |
| 11.0 | 140.2 | 122.2 | 51.0 |

To restore wettability, the core disc was aged in oil for eight weeks (illustrated as step 4 in FIG. 4). The core disc had a contact angle of about 140.2 degrees when high salinity water was used as an injection fluid (strongly oil-wet), where it reduced to about 122.2 degrees when low-salinity (LS₂) was used as an injection fluid (less oil-wet). Finally, surfactant diluted in LS₂ (illustrated as step 9 in FIG. 4) was used as an injection fluid, where the core disc had a contact angle of about 51 degrees (water-wet).

FIG. 9 illustrates facies A cleaned un-aged (left) and crude-aged (right) carbonate discs used in contact angle measurements. Table 4 illustrates the overall results of IFT measurements and Table 5 illustrates overall results for contact angle tests. The surfactant concentration for Samples A-F in Tables 4 and 5 was 1,000 ppm, and the surfactant was ethoxylated alcohol. All values in the Table are approximate.

TABLE 4

| | | IFT between oil and brine (pendant |
|---|---|---|
| Sample | Salinity, ppm | drop method), dynes/cm |
| A | 102,692 | 1.84 |
| B | 92,423 | 1.90 |
| C | 51,346 | 4.14 |
| D | 25,679 | 4.54 |
| E | 1,027 | 4.86 |
| F | ~0 | 5.11 |

TABLE 5

| | | Contact Angle, θ, | Volume of oil droplets |
|---|---|---|---|
| | Salinity, | (captive oil-droplet | beneath the core discs, |
| Sample | ppm | method), in degrees | micro liter |
| A | 102,692 | 20.9 | 1.08 |
| B | 92,423 | 17.6 | 1.20 |
| C | 51,346 | 15.0 | 3.36 |
| D | 25,679 | 12.3 | 2.20 |
| E | 1,027 | 5.4 | 1.55 |
| F | ~0 | 4.8 | 3.65 |

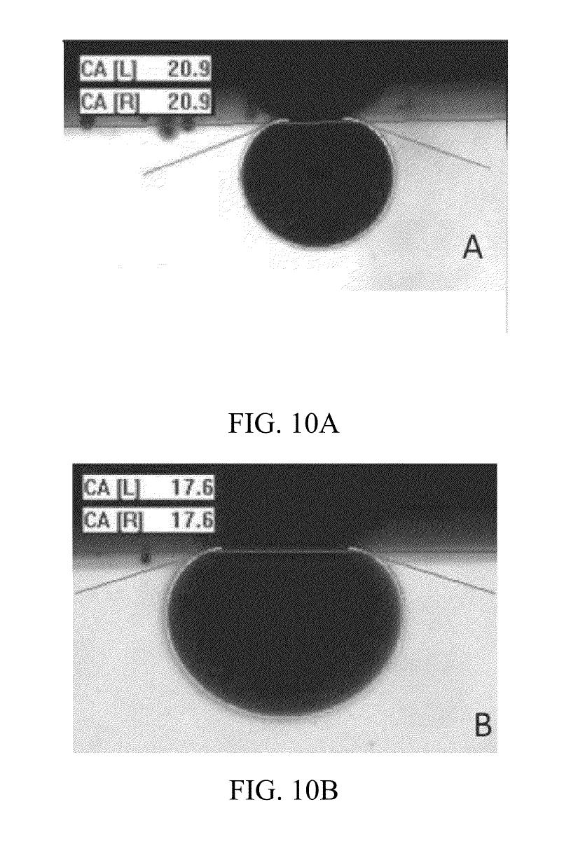

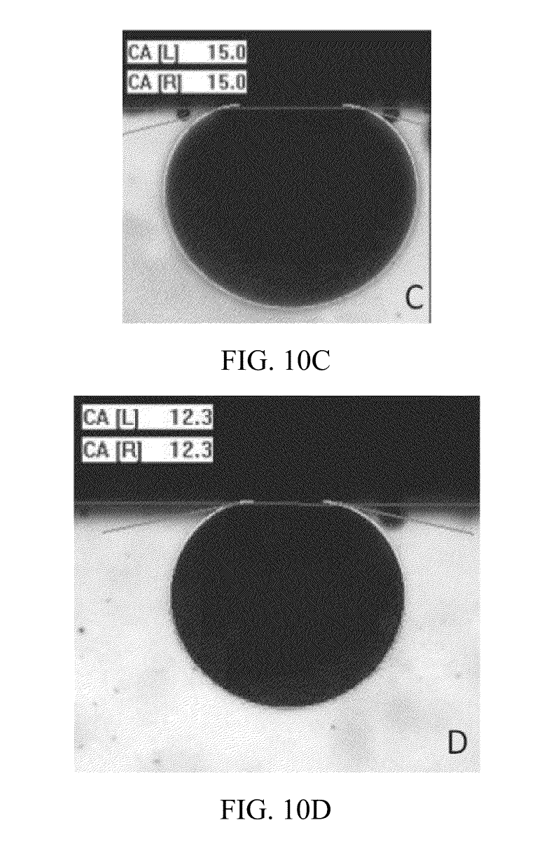

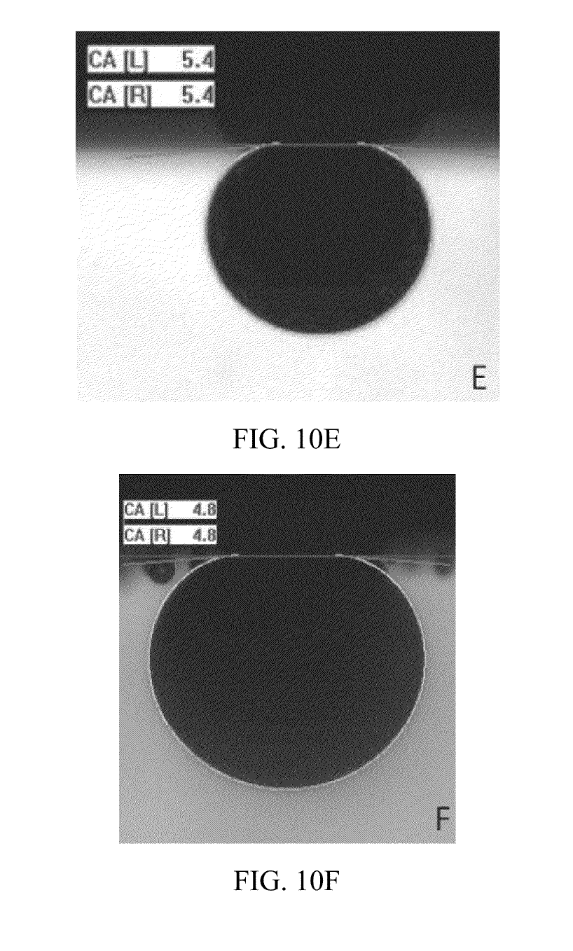

For FA and as illustrated in Table 5 and FIG. 10, the contact angle between the oil-droplet and the cleaned un-aged carbonate disc decreases from around 21 degrees for the case of about 100,000 ppm salinity (surrounding fluid ‘A’—FIG. 10A) to as low as 4.8 degrees for almost zero salinity case (deionized water) (surrounding fluid ‘F’—FIG. 10F). Hence, it is evident that as the salinity decreases, the water-wetness of a cleaned un-aged carbonate disc increases.

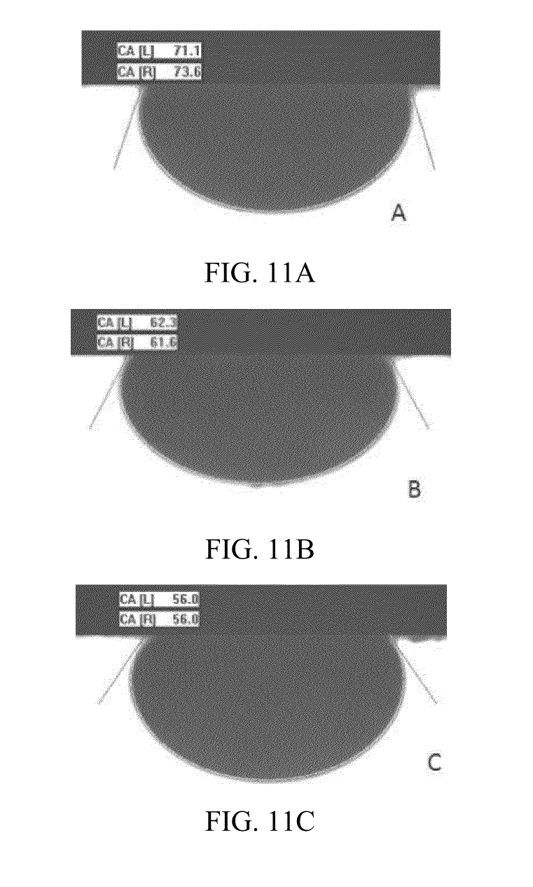

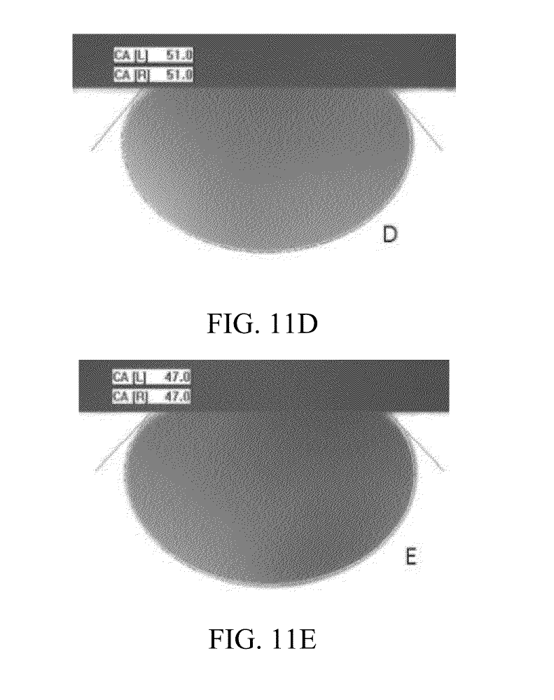

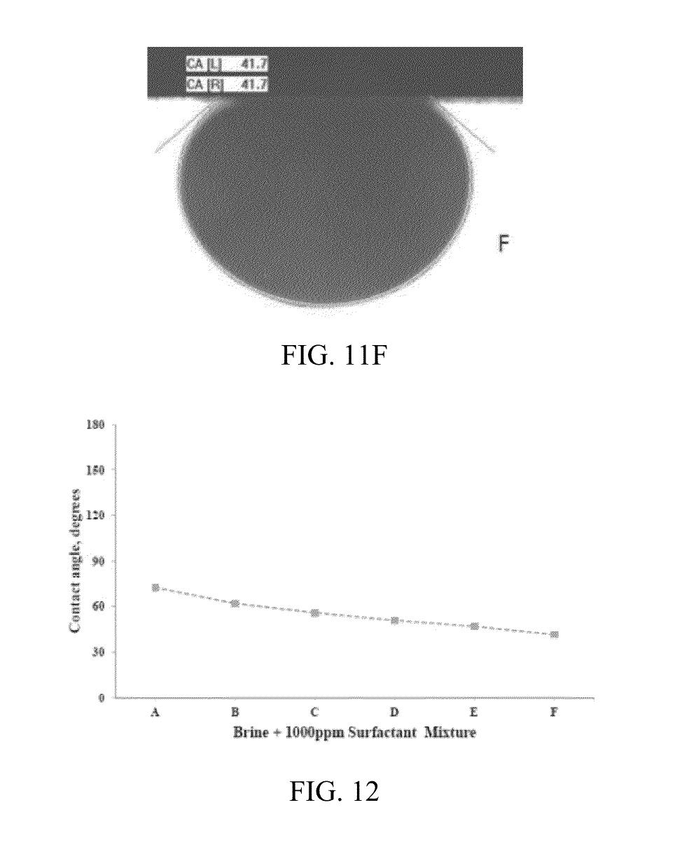

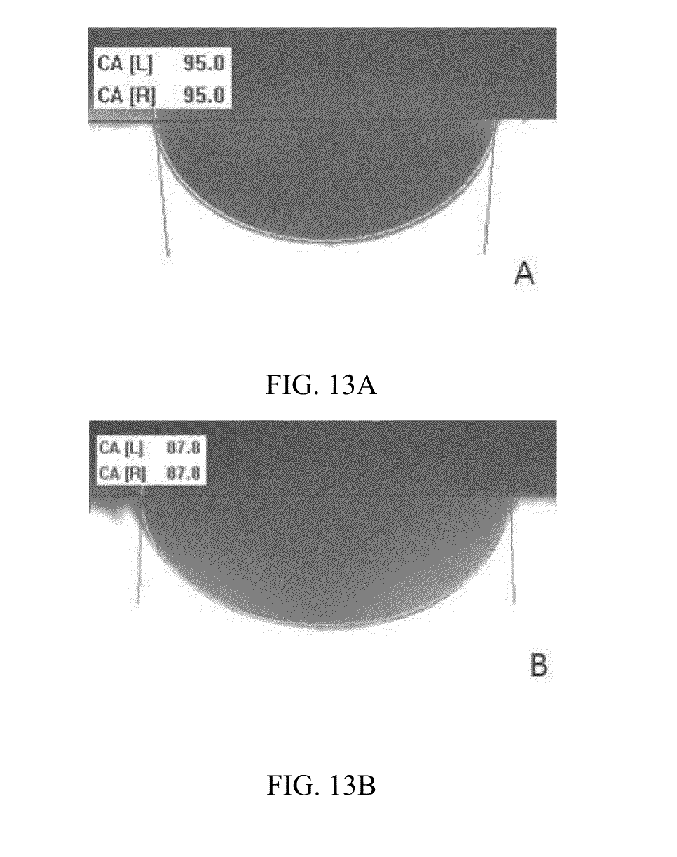

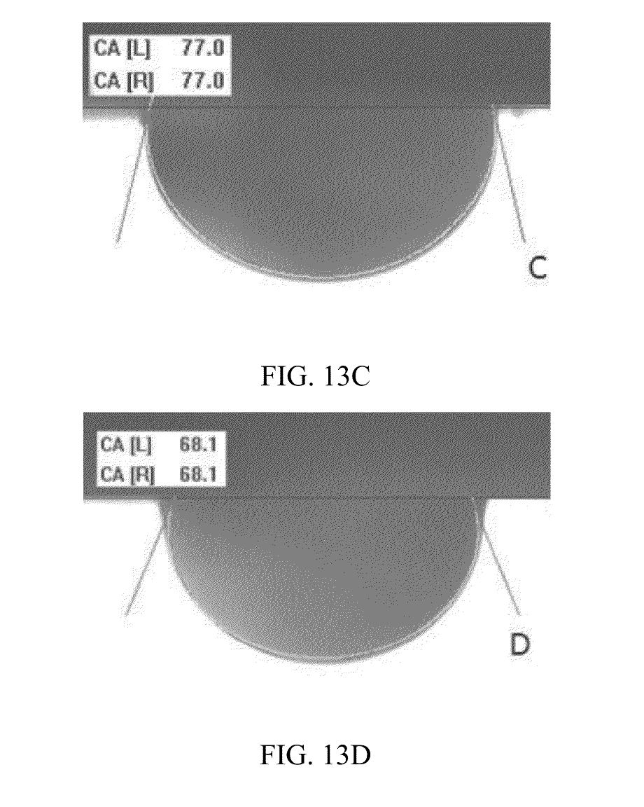

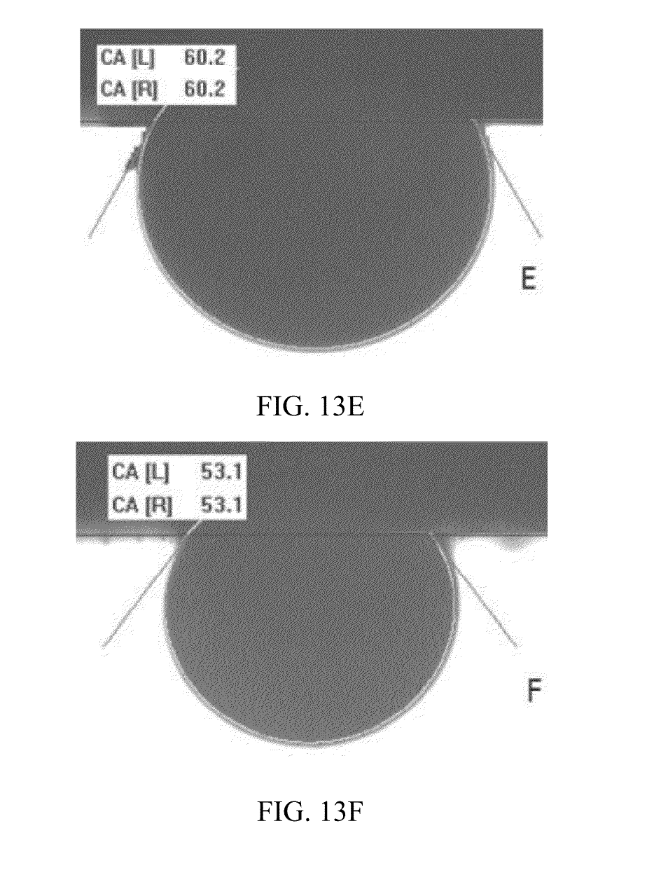

Table 6 and FIGS. 11A-F illustrate contact angles between crude-aged carbonate core discs and oil-droplets in variable salinity brine with 1,000 ppm surfactant for facies FA. FIG. 12 illustrates contact angles for Samples A-F between crude-aged carbonate core discs and oil-droplets in variable salinity brine with 1,000 ppm surfactant for FA. The results in FIG. 12 illustrate that as salinity of the surrounding fluid with the 1,000 ppm surfactant decreases, the wettability alters from intermediate wet to water-wet. Table 7 and FIGS. 13A-F illustrates contact angles between crude-aged carbonate core discs and oil-droplets in variable salinity brine with 1,000 ppm surfactant for FC. The contact angles between the oil-droplet and the aged core disc were measured where the surrounding variable salinity fluid had a 1,000 ppm ethoxylated alcohol surfactant concentration for FC and a 1,000 ppm ethoxylated alcohol for FA. All values in the Table 6 and 7 are approximate.

TABLE 6

| | | Contact Angle, θ, | Volume of oil |
|---|---|---|---|
| Sample | Salinity, ppm | degrees | droplets, μl |
| A | ~100,000 | 72.4 | 2.0 |
| B | 51,346 | 62.0 | 2.0 |
| C | 25,679 | 56.0 | 2.5 |
| D | 12,840 | 51.0 | 2.5 |
| E | 1,027 | 47.0 | 2.5 |
| F | ~0 | 41.7 | 3.0 |

TABLE 7

| | | Contact Angle, θ, | Volume of oil |
|---|---|---|---|
| Sample | Salinity, ppm | degrees | droplets, μl |
| A | ~100,000 | 95.0 | 2.0 |
| B | 51,346 | 87.8 | 2.0 |
| C | 25,679 | 77.0 | 2.5 |
| D | 12,840 | 68.1 | 2.5 |
| E | 1,027 | 60.2 | 2.5 |
| F | ~0 | 53.1 | 3.0 |

FIG. 11 illustrates contact angles between crude-aged carbonate core discs and oil-droplets in variable salinity brine with 1,000 ppm surfactant for FA. The results in FIGS. 11, 12 and 13 and Tables 6 and 7 illustrate that as salinity of the surrounding fluid with the 1,000 surfactant decreases, the wettability alters from intermediate wet to water-wet. Furthermore, the addition of a 1,000 ppm surfactant to the surrounding fluid alters the wettability of the aged carbonate core disc towards intermediate or water-wet (depending on salinity concentration).

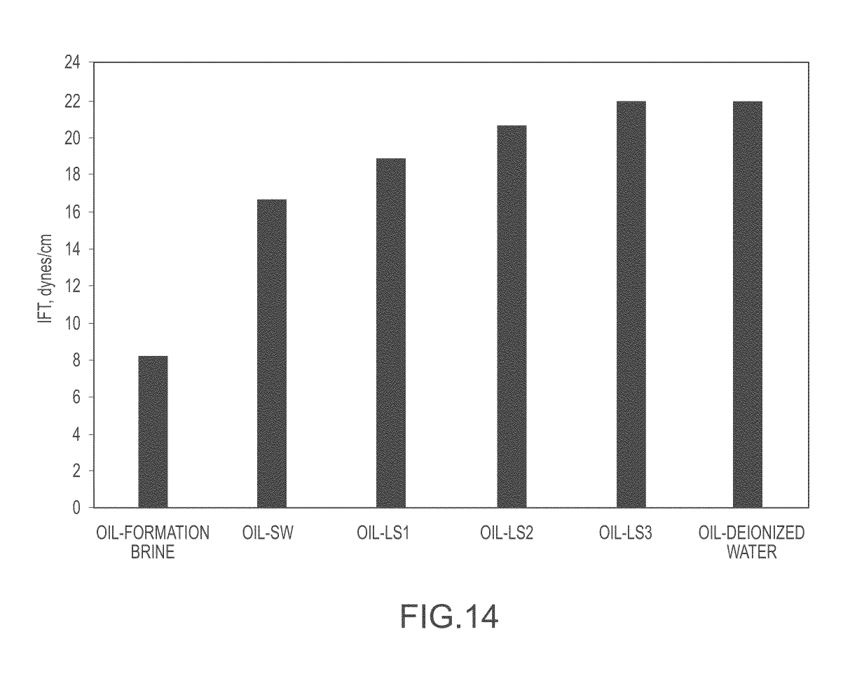

The drop shape analysis system (DSA) was used to measure the IFT between the crude oil and the injected fluid at ambient temperature. It is evident that the IFT measurements in the case of oil-brine with surfactant (as illustrated in Table 4) is lower and even more water-wet, than IFT measurements without surfactant of corresponding salinities (illustrated in Table 8 and FIG. 14), where the IFT values increased as brine's salinity is reduced. FIG. 14 illustrates measurements of IFT between oil-droplets and for variable salinity levels without surfactants. Table 8 also illustrates the pH of the brine, and the contact angle between cleaned un-aged carbonate core slabs and oil droplets in variable salinity. All values in the Table are approximate.

TABLE 8

| | | IFT between | | Contact | |
|---|---|---|---|---|---|
| | | oil and brine | | Angle, θ, | Volume of |
| | | (pendant | | (captive oil | oil droplets |
| Brine | | drop | | droplet | beneath the |
| | Salinity, | method), | | method), | core slabs, |
| Name | ppm | dynes/cm | pH | in degrees | micro liter |
| Formation | >100,000 | 8.26 | 7.17 | 33.3 | 6.5 |
| Brine | | | | | |
| SW | 51,346 | 16.62 | 6.6 | 21.0 | 10.66 |
| LS1 | 25,679 | 18.85 | 6.53 | 17.1 | 10.38 |
| LS2 | 12,840 | 20.75 | 6.31 | 14.8 | 13.17 |
| LS3 | 1,027 | 21.93 | 6.00 | 11.1 | 5.4 |
| Deionized | ~0 | 22.09 | 7.06 | 6.7 | 10.1 |
| water | | | | | |

The foregoing description of the present invention has been presented for purposes of illustration and description. Furthermore, the description is not intended to limit the invention to the form disclosed herein. Consequently, variations and modifications commensurate with the above teachings, and the skill or knowledge of the relevant art, are within the scope of the present invention. The embodiment described hereinabove is further intended to explain the best mode known for practicing the invention and to enable others skilled in the art to utilize the invention in such, or other, embodiments and with various modifications required by the particular applications or uses of the present invention. It is intended that the appended claims be construed to include alternative embodiments to the extent permitted by the prior art.

1. A method to enhance recovery of oil in a hydrocarbon reservoir, comprising:
injecting a low-salinity water into the reservoir; and
injecting a surfactant diluted in an additional low salinity water, wherein the salinity of the additional low-salinity water is less than a salinity of the low-salinity water.

2. The method of claim 1, wherein the low salinity water injection and the surfactant diluted in the additional low salinity water are alternated until a water cut is greater than about 80%.

3. The method of claim 1, further comprising:
injecting a lower salinity water following the low salinity water injection, wherein a salinity of the lower salinity water is lower than the salinity of the low salinity water; and
alternating injections of the lower salinity water injection and the surfactant diluted in the additional low salinity water until a water cut is greater than about 60%.

4. The method of claim 1, wherein the salinity of the additional low water salinity is within about 10% of the salinity of the low salinity water.

5. The method of claim 1, wherein the surfactant is a nonionic surfactant.

6. The method of claim 5, wherein the nonionic surfactant is at least one of an ethoxylated alcohol, a polyoxyethylene glycol alkyl ether, an octaethylene glycol monododecyl ether, a pentaethylene glycol monododecyl ether, a polyoxypropylene glycol alkyl ether, a glucoside alkyl ether, a decyl glucoside, a lauryl glucoside, an octyl glucoside, a polyoxyethylene glycol octylphenol ether, a triton X-100, a polyoxyethylene glycol alkylphenol ether, a nonoxynol-9, a glycerol alkyl esters, a glyceryl laurate, a polyoxyethylene glycol sorbitan alkyl ester, a polysorbate, a sorbitan alkyl ester, a span, a cocamide MEA, a cocamide DEA, a dodecyldimethylamine oxide, a block copolymer of polyethylene glycol a polypropylene glycol, or a poloxamer.

7. The method of claim 1, wherein a concentration of the surfactant is between about 500 ppm to 10,000 ppm.

8. The method of claim 1, wherein a concentration of the surfactant is between about 1,000 ppm and about 5,000 ppm.

9. The method of claim 1, wherein the hydrocarbon reservoir is selected from the group consisting of is a carbonate reservoir, a shale reservoir or a sandstone reservoir.

10. The method of claim 1, wherein the low salinity water is at least one of a desalinated seawater, a diluted seawater, a desalinated hydrocarbon reservoir formation water, a diluted hydrocarbon reservoir water, a river water, a lake water, or a produced hydrocarbon reservoir water.

11. The method of claim 1, wherein a hydrocarbon recovered from the reservoir is a crude oil.

12. The method of claim 1, wherein the salinity of the low salinity water is between about 0 ppm to about 40,000 ppm, and the salinity of the additional low salinity water is less than the salinity of the low salinity water and between about 0 ppm and about 40,000 ppm.

13. A method to enhance oil recovery from a hydrocarbon reservoir, comprising:
injecting high salinity water into the reservoir;
injecting a low salinity water into the reservoir following the injection of the high salinity water, wherein a salinity level of the low salinity water is less than a salinity level of the high salinity water;
injecting a lower salinity water into the reservoir following the injection of the low salinity water, wherein a salinity level of the lower salinity water is less than the salinity of the low salinity water;
injecting a surfactant diluted in the lower salinity water into the reservoir; and
alternating the injection of the low salinity water and the surfactant diluted in the lower salinity water into the reservoir.

14. The method of claim 13, wherein the high salinity water is at least one of a seawater, a reservoir formation water and combinations thereof.

15. The method of claim 13, wherein the low salinity water is at least one of a desalinated seawater, a diluted seawater, a desalinated hydrocarbon reservoir formation water, a diluted hydrocarbon reservoir water, a river water, a lake water, or a produced hydrocarbon reservoir water.

16. The method of claim 13, wherein the lower salinity water is at least one of a desalinated seawater, a diluted seawater, a desalinated hydrocarbon reservoir formation water, a diluted hydrocarbon reservoir water, a river water, a lake water, or a produced hydrocarbon reservoir water, and wherein the surfactant is a nonionic surfactant.

17. The method of claim 13, wherein the reservoir is an oil-wet carbonate reservoir, a shale reservoir or a sandstone reservoir.

18. The method of claim 13, wherein the alternating injection of the low salinity water and the surfactant in the lower salinity water is repeated until a water cut is greater than about 80%.

19. A method to enhance recovery of a hydrocarbon in a reservoir, comprising:
waterflooding the reservoir with a high salinity water;
injecting a first injection of a low salinity water into the reservoir, wherein at least about 0.2 of a pore volume of the reservoir is occupied by the low salinity water;
injecting a surfactant diluted in an additional low salinity water into the reservoir, wherein at least about 0.2 of the pore volume of the reservoir is occupied by the surfactant diluted in the additional low salinity water;
alternating at least one additional injection of the low salinity water into the reservoir and at least one additional injection of the surfactant diluted in the additional low salinity water into the reservoir.

20. The method of claim 19, wherein a salinity of the high salinity water is between about 35,000 ppm to about 60,000 ppm total dissolved solids, and wherein a salinity of the low-salinity water is at most about 50% of the salinity of the high salinity water, and wherein a salinity of the lower-salinity water is about at most about a quarter of the salinity of the high salinity water, ands wherein the alternating step continues until a water cut is greater than about 60%.
